(19) United States
(12) Patent Application Publication
(10) Pub. No.: US 2014/0067430 A1
(43) Pub. Date: Mar. 6, 2014

(54) SYSTEM AND METHOD FOR MANAGING COMPLEX INSURANCE CLAIMS AT ACCOUNT LEVEL

(71) Applicants: Gregory L. Dardick, East Hampton, CT (US); Eric W. Myers, Granby, CT (US)

(72) Inventors: Gregory L. Dardick, East Hampton, CT (US); Eric W. Myers, Granby, CT (US)

(73) Assignee: HARTFORD FIRE INSURANCE COMPANY, Hartford, CT (US)

(21) Appl. No.: 13/602,681

(22) Filed: Sep. 4, 2012

(51) Int. Cl. G06Q 40/08

(52) U.S. Cl. 705/4

(57) ABSTRACT

Provided are systems and methods for administering insurance payments for a loss event that implicates multiple liability insurance policies. In particular, the systems and methods may be used to allocate various portions of an insurance payment across multiple liability insurance policies. The systems and methods further monitor payments allocated to an insurance policy to ensure that the payments allocated to the insurance policy do not exceed defined limits.

### FIELD OF INVENTION

The present invention relates generally to managing complex liability insurance claims, and more particularly, to the proper allocation of losses related to an insured's liability claim across multiple liability insurance policies held by the insured.

### BACKGROUND

Commercial liability insurance provides businesses with protection against mass tort and latent injury claims that may involve, for example, asbestos, mold, toxic torts, environmental hazards and construction defects. These types of commercial liability claims are sometimes referred to as complex insurance claims because they often involve continuous or progressive injuries that implicate numerous insurance policies over multiple policy periods. The proper allocation of a claimed loss across multiple insurance policies over multiple policy periods is particularly important to insurers, because the allocation of the claimed loss can have a significant financial effect to an insurer.

Traditionally, insurance claims have been managed at the individual insurance policy level. This approach, however, presents difficulties when dealing with loss events that span several insurance policies and it is necessary to allocate a loss across several insurance policies. In particular, when managing insurance claims at the individual insurance policy level, it is difficult to see the relationship among multiple insurance policies and manage a complex claim that involves a loss that needs to be allocated across multiple insurance policies over multiple policy periods.

### SUMMARY

In accordance with one aspect of the invention, provided is a computer system for generating a payment associated with an insurance claim. The system includes a data storage device comprising a database and an Account Portal application program, and processor connected to the data storage device for executing the Account Portal application program. The database is adapted to store one or more invoice files, one or more disposition files and one or more electronic financial files. The invoice files contain information regarding an amount to be paid by an insurer for a service rendered by a vendor in connection with one or more insurance policies related to one or more loss events. The disposition files contain information regarding an amount to be paid by the insurer as an indemnity payment and/or a settlement payment in connection with one or more insurance policies related to one or more loss events. Each of the electronic financial files is associated with a corresponding liability insurance policy. The processor executes the Account Portal application program to receive a selection of one or more of the invoice files and/or disposition files to be paid. Additionally, the processor executes the Account Portal application program to allocate, across one or more of the electronic financial files, the amount to be paid by the insurer for the selection of one or more of the invoice files and/or disposition files. Further, the processor executes the Account Portal application program to generate one or more disbursements for the amount to be paid by the insurer for the selection of one or more of the invoice files and/or disposition files for payment.

In accordance with another aspect of the invention, provided is a computerized method for generating a payment associated with an insurance claim. The method is preferably executed by an Account Portal application program executed on a computer processor. In accordance with one embodiment, the method may include storing one or more invoice files, one or more disposition files and one or more electronic financial files. The invoice files contain information regarding an amount to be paid by an insurer for a service rendered by a vendor in connection with one or more loss events. The disposition files contain information regarding an amount to be paid by the insurer as an indemnity payment and/or a settlement payment in connection with one or more loss events. The electronic financial files contain information regarding a corresponding liability insurance policy. The method may also include receiving a selection of one or more of the invoice files and/or disposition files for payment. The method may also include allocating, across one or more of the electronic financial files, the amount to be paid by the insurer for the selection of one or more of the invoice files and/or disposition files. The method may further include generating one or more disbursements (depending on Entity and Payment Type, e.g., invoice vs. disposition) for the amount to be paid by the insurer for the selection of one or more of the invoice files and/or disposition files.

In accordance with yet another aspect of the invention, provided is a non-transitory, tangible computer-readable medium storing instructions adapted to be executed by a computer processor to perform the above-described method for generating a payment associated with an insurance claim

### BRIEF DESCRIPTION OF THE FIGURES

The foregoing summary, as well as the following detailed description of the preferred embodiments, is better understood when read in conjunction with the appended drawings. For the purpose of illustrating the invention, there is shown in the drawings embodiments that are presently preferred, it being understood, however, that the invention is not limited to the specific embodiments disclosed. In the drawings:

FIG. 1 is a block diagram of an insurance computer network, according to an illustrative embodiment of the invention;

FIG. 2 is a block diagram of the insurance computer network of FIG. 1 with a more detailed diagram of a computer system in the insurance computer network, according to an illustrative embodiment of the invention;

FIG. 3 is a schematic illustration of a variety of files used and produced by a computer system shown in FIGS. 1 and 2;

FIG. 4 is flow chart depicting a process for administering and issuing insurance payments in connection with loss events that may be allocated across one ore more insurance policies;

FIG. 5 is a graphical user interface associated with the process depicted in FIG. 4, according to an illustrative embodiment of the invention;

FIG. 6 is another graphical user interface associated with the process depicted in FIG. 4, according to an illustrative embodiment of the invention;

FIG. 7 is another graphical user interface associated with the process depicted in FIG. 4, according to an illustrative embodiment of the invention;

FIG. 8 is another graphical user interface associated with the process depicted in FIG. 4, according to an illustrative embodiment of the invention;

FIG. 9 is another graphical user interface associated with the process depicted in FIG. 4, according to an illustrative embodiment of the invention;

FIG. 10 is another graphical user interface associated with the process depicted in FIG. 4, according to an illustrative embodiment of the invention;

FIG. 11 is another graphical user interface associated with the process depicted in FIG. 4, according to an illustrative embodiment of the invention;

FIG. 12 is another graphical user interface associated with the process depicted in FIG. 4, according to an illustrative embodiment of the invention;

FIG. 13 is another graphical user interface associated with the process depicted in FIG. 4, according to an illustrative embodiment of the invention;

FIG. 14 is another graphical user interface associated with the process depicted in FIG. 4, according to an illustrative embodiment of the invention;

FIG. 15 is another graphical user interface associated with the process depicted in FIG. 4, according to an illustrative embodiment of the invention;

FIG. 16 is another graphical user interface associated with the process depicted in FIG. 4, according to an illustrative embodiment of the invention;

FIG. 17 is another graphical user interface associated with the process depicted in FIG. 4, according to an illustrative embodiment of the invention;

FIG. 18 is another graphical user interface associated with the process depicted in FIG. 4, according to an illustrative embodiment of the invention;

FIG. 19 is another graphical user interface associated with the process depicted in FIG. 4, according to an illustrative embodiment of the invention.

FIG. 20 is another graphical user interface associated with the process depicted in FIG. 4, according to an illustrative embodiment of the invention; and

FIG. 21 is another graphical user interface associated with the process depicted in FIG. 4, according to an illustrative embodiment of the invention.

### DETAILED DESCRIPTION

Before the various embodiments are described in further detail, it is to be understood that the invention is not limited to the particular embodiments described. It will be understood by one of ordinary skill in the art that the systems and methods described herein may be adapted and modified as is appropriate for the application being addressed and that the systems and methods described herein may be employed in other suitable applications, and that such other additions and modifications will not depart from the scope thereof. It is also to be understood that the terminology used is for the purpose of describing particular embodiments only, and is not intended to limit the scope of the claims of the present application.

In the drawings, like reference numerals refer to like features of the systems and methods of the present application. Accordingly, although certain descriptions may refer only to certain Figures and reference numerals, it should be understood that such descriptions might be equally applicable to like reference numerals in other Figures.

The present application is directed to systems and methods for management and payment of one or more invoices and/or settlement payments related to one or more loss events that may implicate one or more commercial-liability insurance policies. The systems and methods of the present application are particularly advantageous for an insurer who may be handling claims related to loss events that implicate multiple insurance policies issued by the insurer. For example, a loss event related to a claim may involve continuous or progressive injuries that implicate numerous insurance policies over multiple policy periods (i.e., injuries and/or damages spanning multiple years). The systems and methods of the present application provide an account level view for a particular insured entity that allows account managers and supervisors of the insurer to see all of the loss events and corresponding insurance policies for the insured entity over the span of multiple years (i.e., multiple policy periods).

More particularly, the systems and methods of the present application allow account managers and supervisors of the insurer to maintain proper accounting of a payment by the insurer by allocating the payment to one or more insurance policies associated with the loss event corresponding to the payment. Proper accounting and allocation of payments by the insurer to one or more insurance policies allows the insurer and its account managers and supervisors to monitor that payments allocated to an insurance policy do not exceed that insurance policy's coverage limits. The systems of the present application may be adapted to automatically monitor payments allocated to an insurance policy to determine if the allocations exceed coverage limits or other limits associated with the insurance policy. This ensures that an insurer's payments to an insured subject to an insurance policy do not exceed the insurer's obligations under the insurance policy agreement.

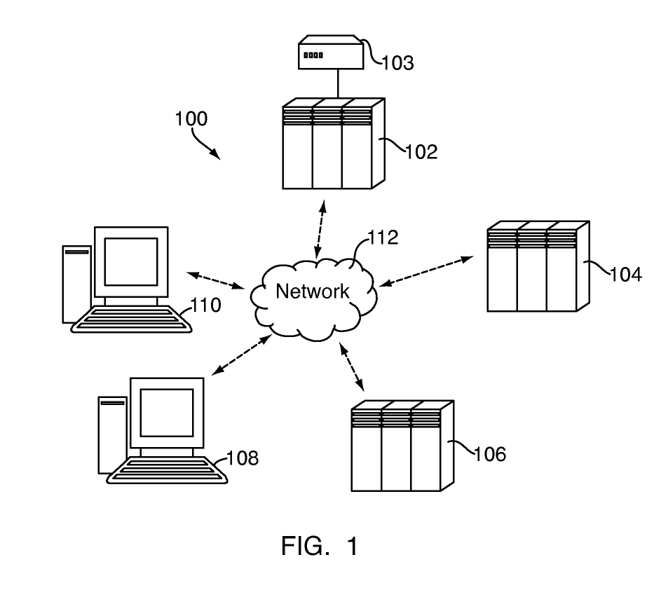

FIG. 1 is a block diagram of an insurance company computer network 100, according to an illustrative embodiment of the invention. The insurance company computer network 100 may include one or more insurance company computer systems 102, 104, 106. The one or more insurance company computer systems 102, 104, 106 are linked to each other via network 112. The one or more computer systems 102, 104, 106 may be separate and distinct computer systems maintained by different entities of the insurance company. For example, the one or more computer systems 102, 104, 106 may belong to different business entities of the insurance company that issue different types of insurance policies and maintain different types of accounting, billing and payment computer systems.

One or more of the insurance company computer systems 102, 104, 106 may be connected to a web server 103. Web server 103 may include one or more applications or server-side application code for generating a secure web-based graphical user interface for communicating with remote computer systems 108, 110. Web server 103 delivers web pages, markup documents and/or electronic messages generated by the server side application code to remote computer systems 108, 110. Remote computer systems 108, 110 communicate with the insurance company computer system 102 via any suitable device that is capable of communication with a web interface, such as a Personal Computer (PC), a portable computing device such as a Personal Digital Assistant (PDA) or smart-phone type device, or any other appropriate storage and/or communication device. While web interface application programs may be implemented on web server 103 in some embodiments, web interface application programs may alternatively be implemented on computer system 102 in other embodiments. Thus, a secure web interface may be provided by computer system 102 without employing a separate web server 103.

Web server 103 may also include a real time, bidirectional, and reliable messaging application to transmit messages to one or more remote computer systems 108, 110. Messages may include facsimiles and/or electronic mail message such as electronic mail messages based on one or more of the messaging protocols including IMAP, POP3, MIME and SMTP for communicating with remote computer systems 108, 110. Remote computer systems 108, 110 may comprise any suitable devices for receiving notifications (e.g., email, facsimile, etc.) from the insurance company computer system 102, such as handheld electronic devices, telephones, facsimile machines, email servers, and/or other transmission device.

The network 112 may be may be one or a combination of a Local Area Network (LAN), a Metropolitan Area Network (MAN), a Wide Area Network (WAN), a proprietary network, a Public Switched Telephone Network (PSTN), a Wireless Application Protocol (WAP) network, a BLUETOOTH® network, a wireless LAN network, and/or an Internet Protocol (IP) network such as the Internet, an intranet, or an extranet. Note that any devices described herein may communicate via one or more such communication networks. In some embodiments, different networks are used to link different components of the insurance computer network 100 together. For example, the systems associated with the insurance company computer network 100, such as the insurance company computer system 102 and the web server 103 may be linked to each other via a private data network. In these embodiments, one or more of the components of insurance company computer network 100 are then linked to external systems and components via a public network such as the Internet or a PSTN. For example, when a remote computer system 108, 110 accesses a webpage served by the web server 103 on the public network 104, the web server 103 may also retrieve and/or transmit data to the insurance company computer system 102 via the private data network. In other embodiments, the web server 103 may not be part of the insurance company 101. Instead, the web server 103 may be operated by third parties.

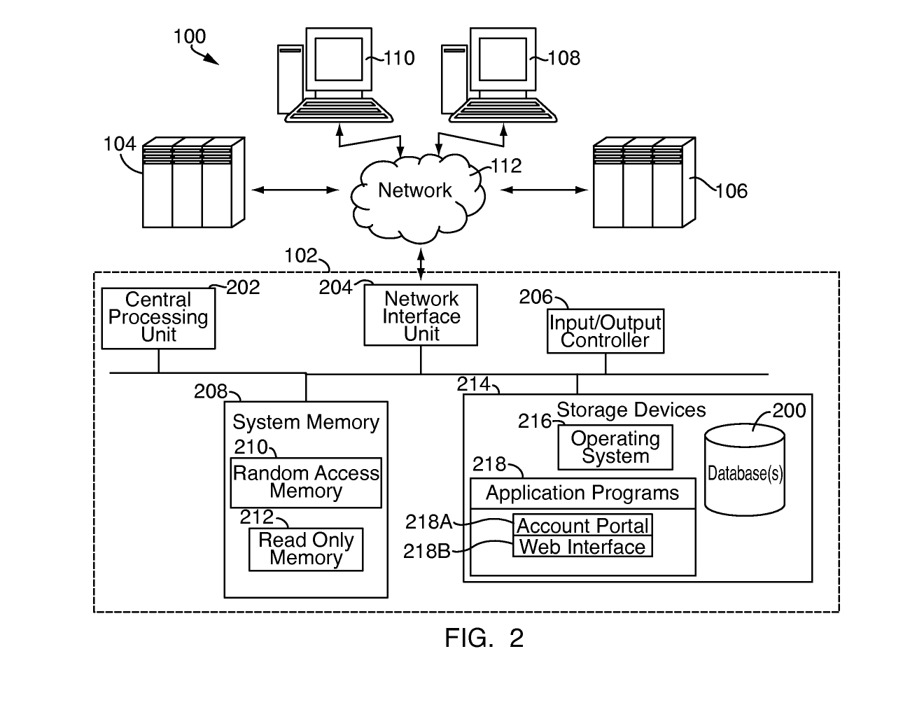

FIG. 2 provides a more detailed block diagram of an insurance company computer system 102 in the insurance computer network 100 of FIG. 1, according to an illustrative embodiment of the invention. Insurance company computer system 102 comprises at least one central processing unit (CPU) 202, system memory 208, which includes at least one random access memory (RAM) 210 and at least one read-only memory (ROM) 212, at least one network interface unit 204, an input/output controller 206, and one or more data storage devices 214. All of these latter elements are in communication with the CPU 202 to facilitate the operation of the insurance company computer system 102. Suitable computer program code may be provided for executing numerous functions. For example, the computer program code may include program elements such as an operating system, a database management system and “device drivers” that allow the processor to interface with computer peripheral devices (e.g., a video display, a keyboard, a computer mouse, etc.) via the input/output controller 206.

The insurance company computer system 102 may be configured in many different ways. In the embodiment shown in FIG. 2, the insurance company computer system 102 is linked, via network 112 (also described in FIG. 1), to other insurance company computer systems 104, 106 and remote computer systems 108, 110. Insurance company computer system 102 may be a conventional standalone computer or alternatively, the function of computer system 102 may be distributed across multiple computing systems and architectures. In some embodiments, insurance company computer system 102 may be configured in a distributed architecture, wherein databases and processors are housed in separate units or locations. Some such units perform primary processing functions and contain at a minimum, a general controller or a processor 202 and a system memory 208. In such an embodiment, each of these units is attached via the network interface unit 204 to a communications hub or port (not shown) that serves as a primary communication link with other servers, client or user computers and other related devices. The communications hub or port may have minimal processing capability itself, serving primarily as a communications router. A variety of communications protocols may be part of the system, including but not limited to: Ethernet, SAP®, SAS®, ATP, BLUETOOTH®, GSM and TCP/IP. The above description of the architecture of insurance computer system 102 is equally applicable to insurance computer systems 104, 106.

The CPU 202 comprises a processor, such as one or more conventional microprocessors and one or more supplementary co-processors such as math co-processors. The CPU 202 is in communication with the network interface unit 204 and the input/output controller 206, through which the CPU 202 communicates with other devices such as insurance computer systems 104, 106 and remote computer systems 108, 110 via network 112. The network interface unit 204 and/or the input/output controller 206 may include multiple communication channels for simultaneous communication with, for example, other processors, servers or client terminals. Devices in communication with each other need not be continually transmitting to each other. On the contrary, such devices need only transmit to each other as necessary, may actually refrain from exchanging data most of the time, and may require several steps to be performed to establish a communication link between the devices.

The CPU 202 is also in communication with the data storage device 214. The data storage device 214 may comprise an appropriate combination of magnetic, optical and/or semiconductor memory, and may include, for example, RAM, ROM, flash drive, an optical disc such as a compact disc and/or a hard disk or drive. The CPU 202 and the data storage device 214 each may be, for example, located entirely within a single computer or other computing device; or connected to each other by a communication medium, such as a USB port, serial port cable, a coaxial cable, an Ethernet type cable, a telephone line, a radio frequency transceiver or other similar wireless or wired medium or combination of the foregoing. For example, the CPU 202 may be connected to the data storage device 214 via the network interface unit 204.

The data storage device 214 may store, for example, (i) an operating system 216 for the insurance company computer system 102; (ii) one or more application programs 218 (e.g., computer program code and/or a computer program product) adapted to direct the CPU 202 in accordance with the present invention, and particularly in accordance with the processes described in detail with regard to the CPU 202; and/or (iii) database(s) 200 adapted to store information that may be utilized to store information required by one or more application programs 218. Various application programs 218 may be executed by insurance company computer system 102—including an Account Portal 218A and Web Interface 218B. The operating system 216 and/or applications 218 may be stored, for example, in a compressed, an uncompiled and/or an encrypted format, and may include computer program code. The instructions of the computer program code may be read into a main memory of the processor from a computer-readable medium other than the data storage device 214, such as from the ROM 212 or from the RAM 210. While execution of sequences of instructions in the program causes the processor 202 to perform the process steps described herein, hard-wired circuitry may be used in place of, or in combination with, software instructions for implementation of the processes of the present invention. Thus, embodiments of the present invention are not limited to any specific combination of hardware and software.

For example, application programs 218 may be implemented in programmable hardware devices such as field programmable gate arrays, programmable array logic, programmable logic devices or the like. Application programs 218 may also be implemented in software for execution by various types of computer processors. An application program of executable code may, for instance, comprise one or more physical or logical blocks of computer instructions, which may, for instance, be organized as an object, procedure, process or function. Nevertheless, the executables of an identified application program need not be physically located together, but may comprise separate instructions stored in different locations which, when joined logically together, comprise the application program and achieve the stated purpose for the application program such as implementing the business rules logic prescribed by system 102. In the present invention an application of executable code may be a compilation of many instructions, and may even be distributed over several different code partitions or segments, among different programs, and across several devices.

The term “computer-readable medium” as used herein refers to any medium that provides or participates in providing instructions to the processor of the computing device (or any other processor of a device described herein) for execution. Such a medium may take many forms, including but not limited to, non-volatile media and volatile media. Non-volatile media include, for example, optical, magnetic, or opto-magnetic disks, such as memory. Volatile media include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASH-EEPROM, any other memory chip or cartridge, or any other medium from which a computer can read.

Various forms of computer readable media may be involved in carrying one or more sequences of one or more instructions to the processor 202 (or any other processor of a device described herein) for execution. For example, the instructions may initially be borne on a magnetic disk of a remote computer (not shown). The remote computer can load the instructions into its dynamic memory and send the instructions over an Ethernet connection, cable line, or even telephone line using a modem. A communications device local to a computing device (e.g., a server) can receive the data on the respective communications line and place the data on a system bus for the processor. The system bus carries the data to main memory, from which the processor retrieves and executes the instructions. The instructions received by main memory may optionally be stored in memory either before or after execution by the processor. In addition, instructions may be received via a communication port as electrical, electromagnetic or optical signals, which are exemplary forms of wireless communications or data streams that carry various types of information.

Database(s) 200 store information accessed by one or more application programs 218 to execute various functions of the one or more application programs 218. Data stored in database(s) 200 may be identified and illustrated herein within one or more application programs 218, but such data may be embodied in any suitable form and organized within any suitable type of data structure. For example, such data may be collected as a single data set, or may be distributed over different locations including over different storage devices, and may exist, at least partially, merely as electronic signals on a system and/or network as shown and describe herein. Database(s) 200 may include a database management system (DBMS) software of a relational database type, such as a DB2 UNIVERSAL DATABASE™ provided by International Business Machines Corporation, an Access™ product provided by Microsoft Corporation or an Oracle® Database product provided by Oracle Corporation for storing and processing information. In some embodiments, database(s) 200 may also provide certain database query functions such as generation of structured query language (SQL) in real time to access and manipulate the data.

Account Portal application program 218A and Web Interface application program 218B may be executed by CPU 202 of insurance company computer system 102 to implement processes for the administration of the insurer's payment obligations related to invoices and settlements associated with a loss event; administration of the insurer's payments for its payment obligations; and administration of the insurer's allocation of payments to one or more insurance policies associated with the loss event. Account Portal application program 218A comprises business logic rules for executing the various functionalities of Account Portal application program 218A. Also, Account Portal application program 218A and Web Interface application program 218B may be executed by CPU 202 to generate a secure web-based graphical user interface for communicating with remote computer systems accessed by account managers and/or account supervisors of the insurer. The secure web-based graphical user interface may be adapted to receive various user inputs for executing the various functionalities of Account Portal application program 218A.

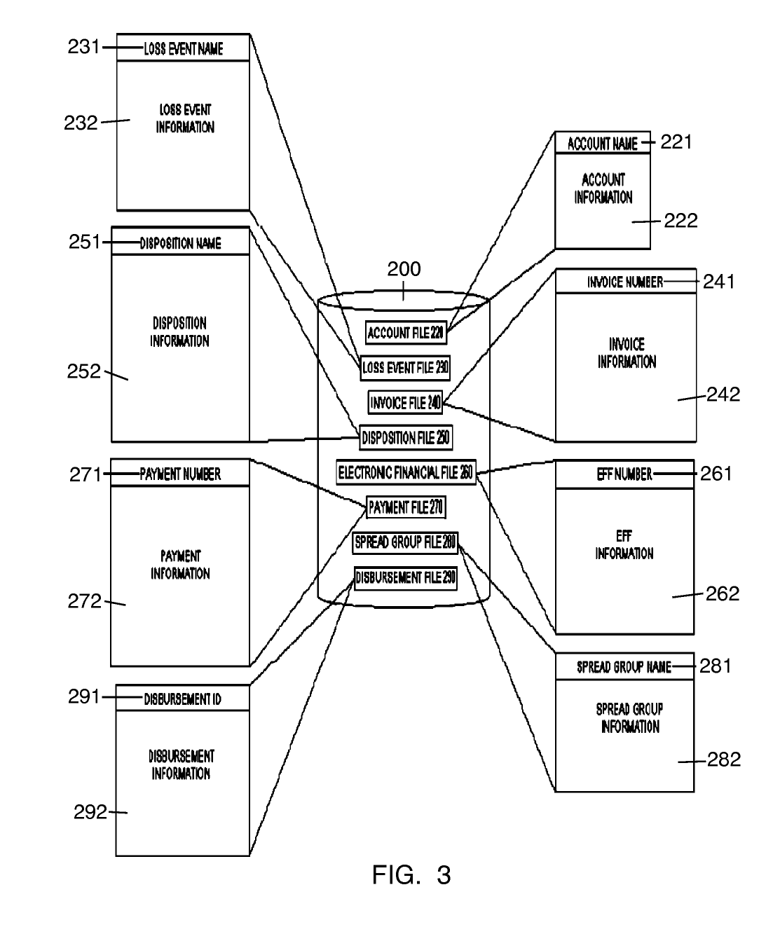

Database(s) 200 may store data for accounts, loss events, insurance policies, payments, payment allocations, and disbursements. This data may be stored in various combinations in various data structures. In one embodiment, as shown in FIG. 3 for example, database(s) 200 may store account files 220, loss event files 230, invoice files 240, disposition files 250, electronic financial files 260, payment files 270, spread group files 280, and disbursement files 290.

An account file 220 corresponds to an insured entity, its corporate predecessors, successors and/or any other related entities that may share insurance coverage under an insurance policy. An account file 220 provides a central repository for information and/or links to information associated with the insured entity. As shown in FIG. 3, for example, an account file 220 may comprise an account name 221 identifying the account file and account information 222. Account information 222 may include information regarding the insured entity to which the account file corresponds, information regarding one or more insurance policies associated with the insured entity, and information regarding one or more loss events associated with the insured entity and the one or more insurance policies.

A loss event file 230 comprises information and/or links to information associated with an insured entity's loss event. As shown in FIG. 3, for example, loss event file 230 may comprise a loss event name 231 identifying the loss event file 230 and loss event information 232. Loss event information 232 may include information regarding an associated account name corresponding to an insured entity associated with the loss event, information regarding a lawsuit linked to the loss event, information regarding one or more claimants linked to the loss event, information regarding one or more sites linked to the loss event, information regarding the injury/damage associated with the loss event, information regarding one or more EFFs corresponding to insurance policies linked to the loss event, and information regarding the status of the loss event as either OPEN or CLOSED for processing.

An invoice file 240 represents a payment request or a payable item for a service rendered by a vendor in connection with an insured entity's loss event. For example, an invoice file 240 may be a payment request by legal defense counsel for legal services rendered for an insured entity in connection with a loss event. As shown in FIG. 3, for example, an invoice file 240 may be identified by an invoice number 241, which is preferably unique for each account, loss event and payee combination. Also, as shown in FIG. 3, an invoice file 240 may comprise invoice information 242. Invoice information 242 may include, among other things, an associated account name, associated loss event(s), payee, Nature of Benefit (NOB) code(s), loss event(s) insurer total, and NOB code(s) total(s).

The associated account name in invoice file 240 corresponds to one or more insured entities and identifies and links the invoice file 240 with the one or more corresponding insured entities. Associated loss event(s) in invoice file 240 identify one or more loss events to which the invoice file 240 corresponds. The services identified in an invoice file 240 may have been rendered in connection with one or more loss events. For example, an invoice file 240 may identify legal services rendered by one law office in connection with multiple loss events. The payee information identifies the payees corresponding to the invoice file 240. Further, the payee information identifies a primary payee to whom a payment check is to be made out. The Nature of Benefit (NOB) Code(s) refer to the different benefit categories to which a payment may be allocated in an insurance company accounting system. For example, different NOB codes may be identified for different benefit categories, such as:

| | NOB Definition |
|---|---|
| 01 | Death/Funeral |
| 02 | Perm Tot Disability |
| 03 | Maj Perm. Part Disab |
| 04 | Min Perm. Part Disab |
| 05 | Indem or if WC, then Temp Disab |
| 06 | Other Medical |
| 09 | Contract Medical |
| 10 | Voc Rehab. - Maint |
| 11 | Voc Rehab. - Eval |
| 12 | Voc Rehab. - Train |
| 14 | Supplemental Ben |
| 15 | Hospital |
| 16 | Doctor |
| 17 | Physical Rehab |
| 20 | Voc Rehab Counsel (VRC) |
| 29 | Punitive Damages |
| 33 | Pre-judgmnt Inter on Judgmnt |
| 34 | Post-judgmnt Inter on Judgmnt |
| 70 | Rptr's fees, Misc legal Exp |
| 71 | Attorney's fees |
| 72 | Special Investigator |
| 73 | Medical Exam |
| 75 | Appraisal fees, etc |
| 76 | Miscellaneous Exp |
| 77 | Indep Adjstr's Fee |
| 82 | Settlement of Claim Under Basic |
| 84 | Altern Dispute Resolut Fee |
| 85 | Declar Judgmnt Exp (//) |

The Loss Event(s) Insurer Total(s) represent the amount(s) to be paid by an insurer corresponding to the loss event(s) associated with the invoice file 240. The Loss Event(s) Insurer Total(s) may be determined based on an Original Amount requested by a vendor. The Original Amount may be reduced to a Total Amount subject to any applicable adjustment and/or reductions. Then, the Total Amount may be further reduced to an Insurer Share Amount based on an Insurer Share Percentage, which is determined based on insurance coverage allocations among other insurers. For example, if it is determined that the Insurer Share Percentage is 50%, then the Insurer Share Amount is 50% of the Total Amount. The Insurer Sharer Amount preferably reflects the Share Percentage for all related entities of the insurer.

Also, portions of the Total Amount may be allocated to one or more loss events associated with the invoice file 240. For example, if 45% of the services identified in invoice file 240 were rendered in connection with a first loss event and 55% of the services identified in invoice file 240 were rendered in connection with a second loss event, then 45% of the Total Amount would be allocated to the first loss event and 55% percent of the Total Amount would be allocated to second loss event. The portions of the Total Amounts allocated to one or more loss events are referred to as the Loss Event Totals. If there is only one loss event associated with the invoice file 240, then the Loss Event Total is the same as the Total Amount.

Further, the Loss Event(s) Insurer Total(s) may be calculated by taking the Insurer Share Amount and allocating portions of the Insurer Share Amount to one or loss events. Alternatively, the Loss Event(s) Insurer Total(s) may be calculated by taking the Loss Event Totals and applying the Insurer Share Percentage. Accordingly, the Insurer's share of the Total Amount corresponding to one or more loss events may be calculated. Additionally, the NOB Code(s) Total(s) represent the allocation of portions of a Loss Event Insurer Total to one or more NOB Codes.

Although not shown in FIG. 3, invoice file 240 may comprise additional information, including invoice date, date received, due date, and required supporting documentation. The Invoice Date is the date the invoice was prepared. The Date Received is the date the invoice was received. The Due Date is the date the invoice should be paid by. The Required Supporting Documentation identifies any documentation that is required for any invoice or disposition (i.e., settlement).

A disposition file 250 represents an indemnity payment and/or a settlement payment of a claim in connection with an insured entity's loss event. For example, a disposition file 250 may be an indemnity payment to an insured entity or a settlement payment to a claimant or their legal representative in connection with a loss event. As shown in FIG. 3, for example, a disposition file 250 may be identified by a disposition name 251. Also, as shown in FIG. 3, a disposition file 250 may comprise disposition information 252. The disposition information 252 may include, among other things, an associated account name, associated loss event(s), payee, Nature of Benefit (NOB) code(s), Loss Event(s) Insurer Total(s), disposition type, claimant(s) or site(s).

The associated account name in the disposition file 250 corresponds to one or more insured entities, and identifies and links the disposition file 250 with the one or more corresponding insured entities. The associated loss event(s) in disposition file 250 identify one or more loss events to which the disposition file 250 corresponds. The indemnity payment and/or settlement payment may be related to one or more loss events. The payee information identifies the payees corresponding to disposition file 250. Further, the payee information identifies a primary payee to whom a payment check is to be made out. The Nature of Benefit (NOB) Code(s) refer to the different benefit categories to which an indemnity payment or settlement payment may be allocated in an insurance company accounting system. For example, different NOB codes may be identified for different benefit categories, such as:

| | NOB Definition |
|---|---|
| 01 | Death/Funeral |
| 02 | Perm Tot Disability |
| 03 | Maj Perm. Part Disab |
| 04 | Min Perm. Part Disab |
| 05 | Indem or if WC, then Temp Disab |
| 06 | Other Medical |
| 09 | Contract Medical |
| 10 | Voc Rehab. - Maint |
| 11 | Voc Rehab. - Eval |
| 12 | Voc Rehab. - Train |
| 14 | Supplemental Ben |
| 15 | Hospital |
| 16 | Doctor |
| 17 | Physical Rehab |
| 20 | Voc Rehab Counsel (VRC) |
| 29 | Punitive Damages |
| 33 | Pre-judgmnt Inter on Judgmnt |
| 34 | Post-judgmnt Inter on Judgmnt |
| 70 | Rptr's fees, Misc legal Exp |
| 71 | Attorney's fees |
| 72 | Special Investigator |
| 73 | Medical Exam |
| 75 | Appraisal fees, etc |
| 76 | Miscellaneous Exp |
| 77 | Indep Adjstr's Fee |
| 82 | Settlement of Claim Under Basic |
| 84 | Altern Dispute Resolut Fee |
| 85 | Declar Judgmnt Exp (//) |

The Loss Event(s) Insurer Total(s) represent the amount(s) to be paid by an insurer corresponding to loss event(s) associated with the disposition file 250. The Loss Event(s) Insurer Total(s) may be determined based on a Total Amount of the indemnity or settlement payment. Then, the Total Amount may be reduced to an Insurer Share Amount based on an Insurer Share Percentage, which is determined based on insurance coverage allocations among other insurers. For example, if it is determined that the Insurer Share Percentage is 50%, then the Insurer Share Amount is 50% of the Total Amount. The Insurer Sharer Amount preferably reflects the Share Percentage for all related entities of the insurer.

Also, portions of the Total Amount may be allocated to one or more loss events associated with the disposition file 250. For example, if 45% of the indemnity or settlement payment in disposition file 250 is related to a first loss event and 55% of the indemnity or settlement payment in disposition file 250 is related to a second loss event, then 45% of the Total Amount would be allocated to the first loss event and 55% percent of the Total Amount would be allocated to second loss event. The portions of the Total Amounts allocated to one or more loss events are referred to as the Loss Event Totals. If there is only one loss event associated with the disposition file 250, then the Loss Event Total is the same as the Total Amount.

Further, the Loss Event(s) Insurer Total(s) may be calculated by taking the Insurer Share Amount and allocating portions of the Insurer Share Amount to one or loss events. Alternatively, the Loss Event(s) Insurer Total(s) may be calculated by taking the Loss Event Totals and applying the Insurer Share Percentage. Accordingly, the Insurer's share of the Total Amount corresponding to one or more loss events may be calculated. Additionally, NOB Code(s) Total(s) represent the allocation of portions of a Loss Event Insurer Total to one or more NOB Codes.

The disposition type identifies whether the disposition file 250 relates to a partial disposition or a final disposition. A partial disposition refers to a disposition related to an indemnity payment that may be followed by additional indemnity payments in the future. Final disposition refers to a final settlement payment that fully resolves a claim. The Claimant(s)/Site(s) information identifies the claimant(s) and site(s) that are part of the disposition. The claimants may be identified with information such as claimant's social security number, claimant's injury and claimant's status. The sites may be identified with information such as the site's damage type and the site's status. The claimant's status and site's status refers to the status 218A as either OPEN or CLOSED for processing. Information regarding the claimant's status and site's status may be stored in the Account Portal application program or in a remote system in communication with the Account Portal application program. For example, information regarding the claimant's status and site's status may be stored in an Electronic Claim Litigation Information Processing System (ECLIPS).

An Electronic Financial File (EFF) 260 corresponds to an insured entity's insurance policy and comprises information regarding one ore more loss events that are associated with the insurance policy. As shown in FIG. 3, for example, an EFF 260 may be identified by an EFF number 261 and may comprise EFF information 262. The EFF information 262 may include information regarding an associated account name corresponding to the insured entity associated with the one or more loss events, information regarding one or more loss events, information identifying an insurance policy (e.g., insurance policy number) corresponding to EFF 260, information identifying the insurer entity that issued the insurance policy corresponding to EFF 260, information regarding spread groups which are linked to EFF 260 and allocate some portion of a payment associated with a loss event to EFF 260, and information regarding the status of the loss event as either OPEN or CLOSED for processing.

A payment file 270 comprises information that allows a payment amount that is associated with one or more loss events to be allocated to one or more EFFs 260 corresponding to the one or more loss events. As shown in FIG. 3, for example, a payment file 270 may be identified by a payment number 271 and may comprise payment information 272. The payment information 272 may include information regarding an associated account name corresponding to the insured entity associated with the one or more loss events, information identifying a primary payee to whom a disbursement (i.e., payment check) is to be made out, information identifying a selection of payable items (i.e., invoice files 240 and/or disposition files 250) corresponding to the account name and primary payee of payment file 270, information regarding one or more loss events associated with the selected payable items, information regarding an insurer total to be paid by the insurer for the selected payable items, information regarding a selection of EFFs that are associated with the account name of payment file 270 and the one or more loss events associated with the selected payable items, information regarding the EFF allocation of the insurer total to be paid by the insurer across the selection of EFFs, and information regarding the status of the payment file that confirms whether the selected payable items have been validated and are ready for payment.

A spread group file 280 refers to an EFF allocation that was previously defined in a payment file 270 and was saved to the Account Portal application program 218A. Accordingly, a spread group file 280 defines an allocation that was previously defined for allocating a payment by the insurer across a selection of EFFs. As shown in FIG. 3, for example, a spread group file 280 may be identified by a spread group name 281 and may comprise spread group information 282. The spread group information 282 may include information regarding an associated account name, information regarding one or more associated loss events, information regarding the associated selection of EFFs, and information regarding the EFF allocation, which defines percentage of a payment by the insurer allocated to the selection of EFFs.

A disbursement file 290 represents an actual check that is to be issued. As shown in FIG. 3, for example, a disbursement file 290 may be identified by a disbursement ID 291 and may comprise disbursement information 292. The disbursement information 292 may include information regarding the disbursement amount, the payment method, the target system, the due date, the insurance policy number and the status. The insurer may comprise one or more related business entities of the insurance company that may issue different types of insurance policies and maintain different types of accounting, billing and payment computer systems. Accordingly, the disbursement transaction should be entered to the accounting, billing and payment computer system associated with the insurer entity that issued the insurance policy to which the disbursement was allocated. The target system corresponds to the appropriate accounting, billing and payment computer system for entering the disbursement transaction. The insurance policy number refers to the insurance policy number corresponding to the EFF file 260 to which the payment was allocated. The status of the disbursement indicates whether the disbursement transaction is in progress or completed.

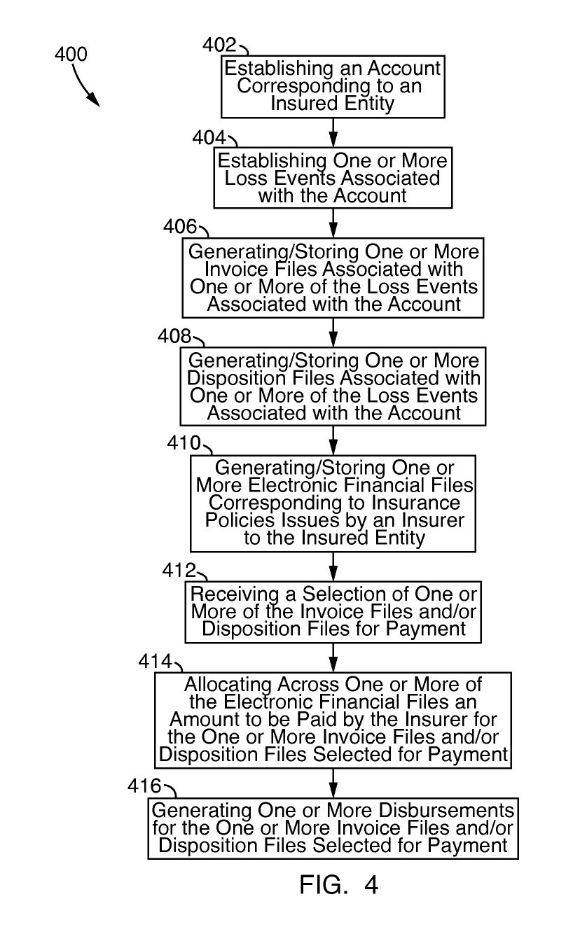

Referring to FIG. 4, the CPU 202 of insurance company computer system 102 may execute Account Portal application program 218A and Web Interface application program 2188 to implement a computerized method 400 for the administration of the insurer's payment obligations related to invoices and settlements associated with a loss event; administration of the insurer's payments for its payment obligations; and administration of the insurer's allocation of payments to one or more insurance policies associated with the loss event. Account Portal application program 218A comprises business logic rules for executing the various functionalities of Account Portal application program 218A in accordance with computerized method 400. Also, Account Portal application program 218A and Web Interface application program 218B may be executed by CPU 202 to generate a secure web-based graphical user interface for communicating with remote computer systems accessed by account managers and/or account supervisors of the insurer. The secure web-based graphical user interface may be adapted to receive various user inputs for executing the various functionalities of Account Portal application program 218A.

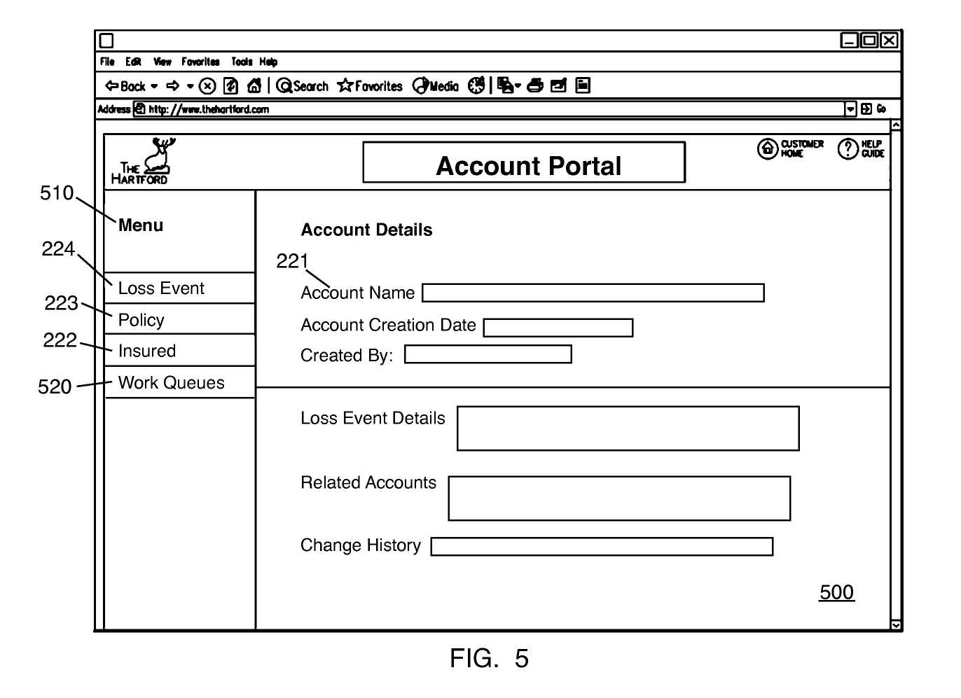

The method 400 may include a step 402 of establishing an account corresponding to an insured entity. The account referred to in step 402 corresponds to the above-described account file 220 and may thus be defined in accordance with the above description of account file 220. Accordingly, the insured entity corresponding to the account may include its corporate predecessors, successors and/or any other related entities that may share insurance coverage under an insurance policy. Account Portal application program 218A and Web Interface application program 218B may be executed by CPU 202 to generate a secure web-based graphical user interface for receiving user inputs for defining account file 220 and for providing a graphical representation of account file 220, as shown in FIG. 5. An account file 220 provides a central repository for information and/or links to information associated with the insured entity. As shown in FIG. 5, for example, an account file 220 may comprise an account name 221 identifying the account file, information regarding the insured entity 222 to which the account file corresponds, information regarding one or more insurance policies 223 associated with the insured entity 222, and information regarding one or more loss events 224 associated with the insured entity 222 and the one or more insurance policies 223.

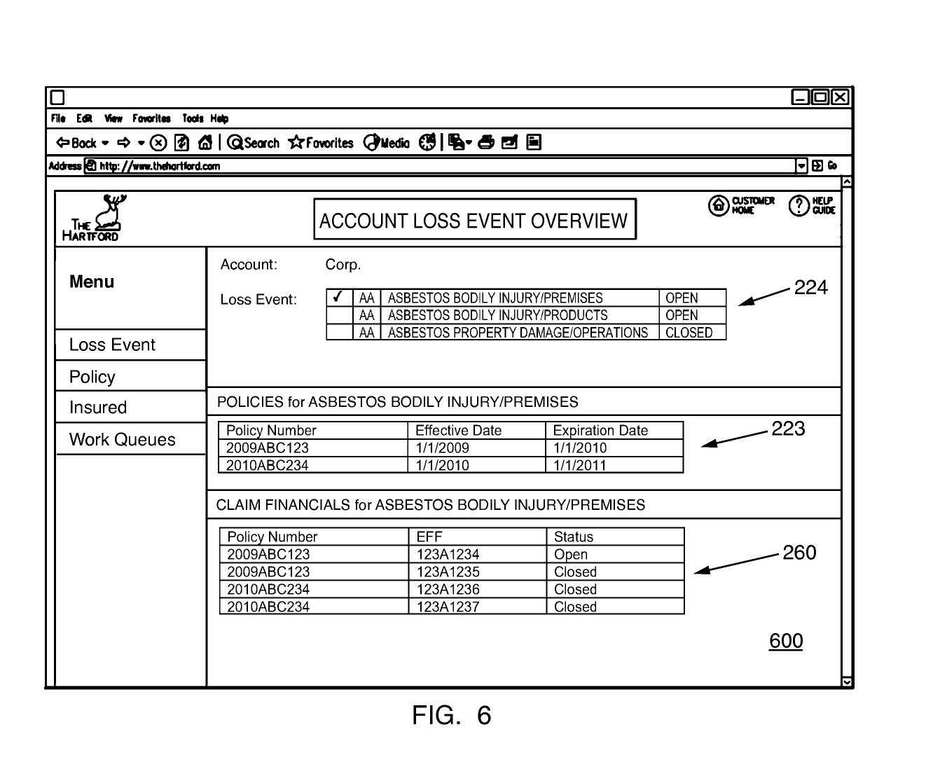

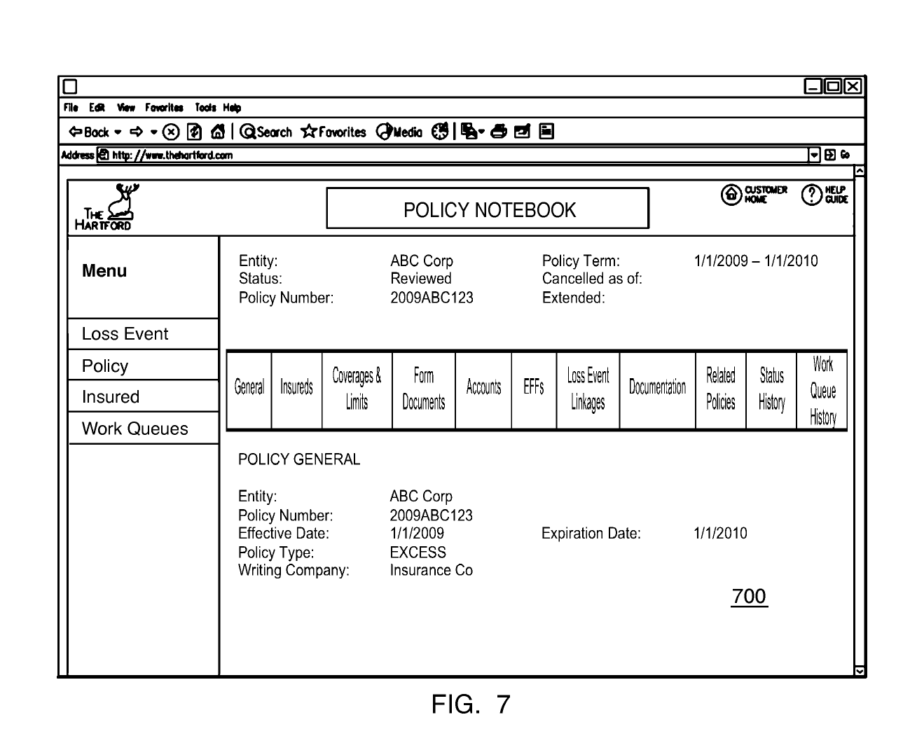

Method 400 may also include a step 404 of establishing one ore more loss events associated with the account. The one or more loss events referred to in step 404 correspond to the above-described loss event file 230 and may thus be defined in accordance with the above description of loss event file 230. For example, loss event file 230 may comprise information regarding a specific tort; coverage type; coverage part; an associated account name corresponding to an insured entity associated with the loss event; a lawsuit linked to the loss event; one or more claimants linked to the loss event; one or more sites linked to the loss event; the injury/damage associated with the loss event; one or more EFFs corresponding to insurance policies linked to the loss event; and the status of the loss event as either OPEN or CLOSED for processing. FIG. 6 shows an Account Loss Event Overview graphical user interface 600 that displays the loss events 224 associated with the account, the insurance policies 223 associated with a loss event 224 and the EFFs 260 associated with a loss event 224. The Policy Notebook graphical user interface 700 displays detailed information regarding the insurance policy. Accordingly, Account Portal application program 218A provides an account level view that allows a user to see all of the loss events 224 associated with an insured entity. Further, for each of the loss events associated with an insured entity, Account Portal application program 218A provides an account level view that allows a user to see all the insurance policies 223 related to a loss event 224. To view detailed information regarding an insurance policy associated with a loss event 224, an insurance policy displayed in the Account Loss Event Overview graphical user interface 600 can be selected to launch a Policy Notebook graphical user interface 700 as shown in FIG. 7.

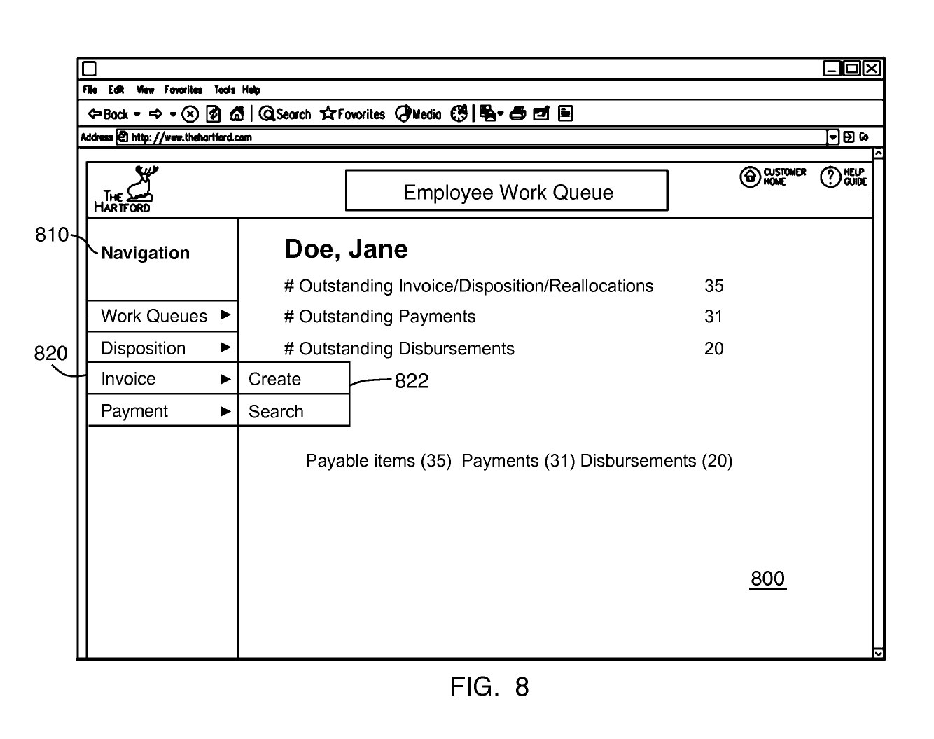

Method 400 may also include a step 406 of generating and storing one or more invoice files associated with one or more of the loss events of step 404, which are associated with the account of step 402. The one or more invoice files referred to in step 406 correspond to the above-described invoice file 240 and may thus be generated in accordance with the above description of invoice file 240. Account Portal application program 218A and Web Interface application program 218B may be executed by CPU 202 to generate secure web-based graphical user interfaces for receiving user inputs for generating an invoice file 240 and for providing a graphical representation of invoice file 240, as shown in FIGS. 8-11. An invoice file 240 represents a payment request for a service rendered by a vendor in connection with an insured entity's loss event. For example, an invoice file 240 may be a payment request by legal defense counsel for legal services rendered for an insured entity in connection with a loss event.

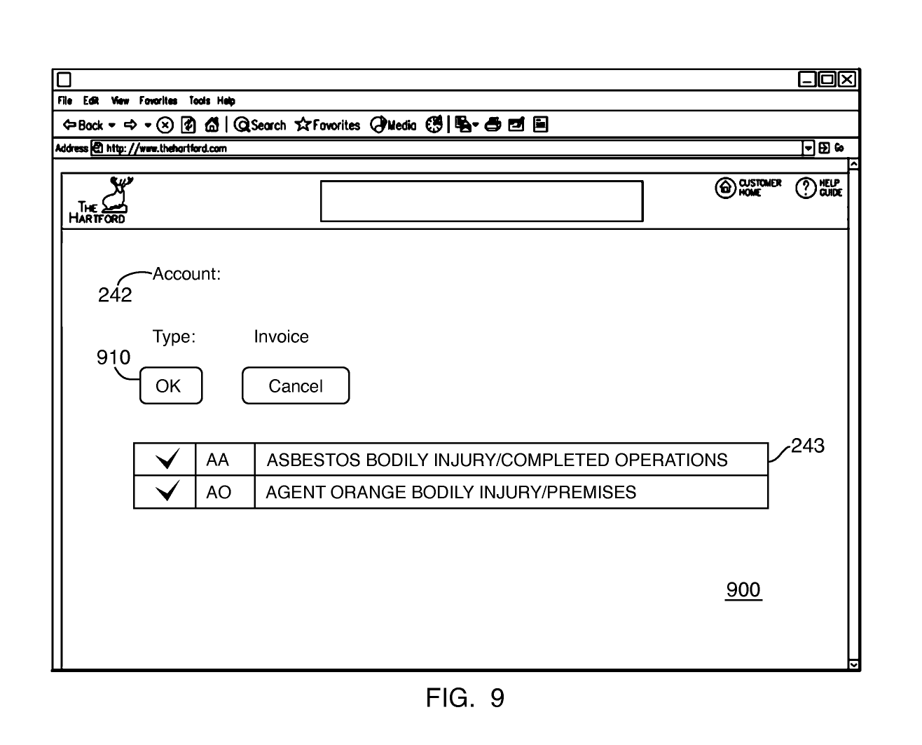

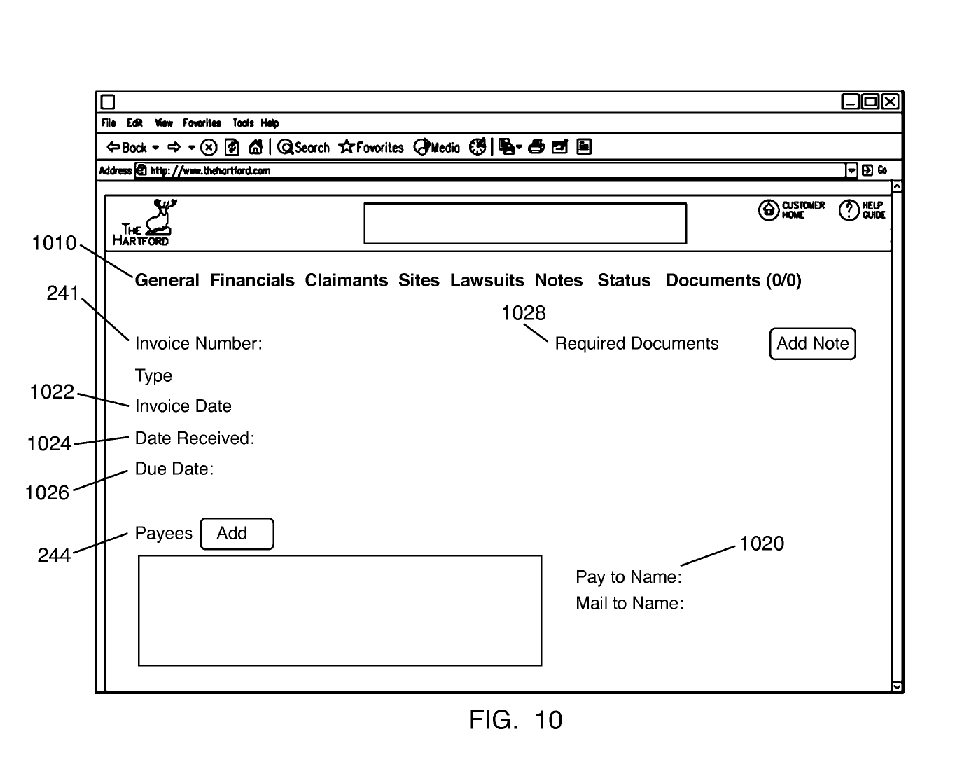

A user may generate an invoice file 240 by accessing secure web-based graphical user interfaces generated by Account Portal application program 218A and Web Interface application program 218B and providing certain user inputs. Step 406 of generating and storing one or more invoice files is described herein with reference to the illustrative embodiments of the secure web-based graphical user interfaces shown in FIGS. 8-11. In one embodiment, a user may begin generating an invoice file by accessing an Account Portal graphical user interface 500 as shown in FIG. 5 and selecting “Work Queues” 520 from the Menu 510. The user will be directed to a Work Queue graphical user interface 800 as shown in FIG. 8. From Work Queue graphical user interface 800, the user can select “Invoice” 820 from the Menu 810 and choose the “Create” option 822 to launch the Invoice Notebook to begin creating an invoice file 240. Alternatively, the user may generate an invoice file by accessing an Account Portal graphical user interface 500 as shown in FIG. 5 and selecting the Invoice menu item from the Navigation Menu 510 to launch the Invoice Notebook to begin creating an invoice file 240. The user will be directed to a graphical user interface 900 as shown in FIG. 9. In the graphical user interface 900 of FIG. 9, a user can enter the account name 242 and identify the loss events 243 associated with the invoice file 240. Once the user inputs the account name 242 and the loss events 243 associated with the invoice file 240 and selects the OK button 910, the user is directed to the Invoice Notebook graphical user interface 1000 of FIG. 10 and begin creating an invoice file 240.

In the Invoice Notebook graphical user interface 1000 of FIG. 10, there are several tabs that can be selected by the user to define different information regarding the invoice file 240. The graphical user interface 1000 of FIG. 10 shows a General tab 1010 associated with the creation of an invoice file 240. The graphical user interface 1000 allows the user to enter information regarding the invoice number 241, payees 244, primary payee 1020, invoice date 1022, date received 1024, due date 1026, and supporting documentation 1028. Invoice number 241 is preferably unique for each account, loss event and payee combination. Payee 244 represents information identifying the payees corresponding to the invoice file 240. Further, the user may identify a primary payee 1020 to whom a payment check is to be made out. The invoice date 1022 is the date the invoice was prepared. The date received 1024 is the date the invoice was received. The due date 1026 is the date the invoice should be paid by. The supporting documentation 1028 identifies any documentation that is required with the invoice.

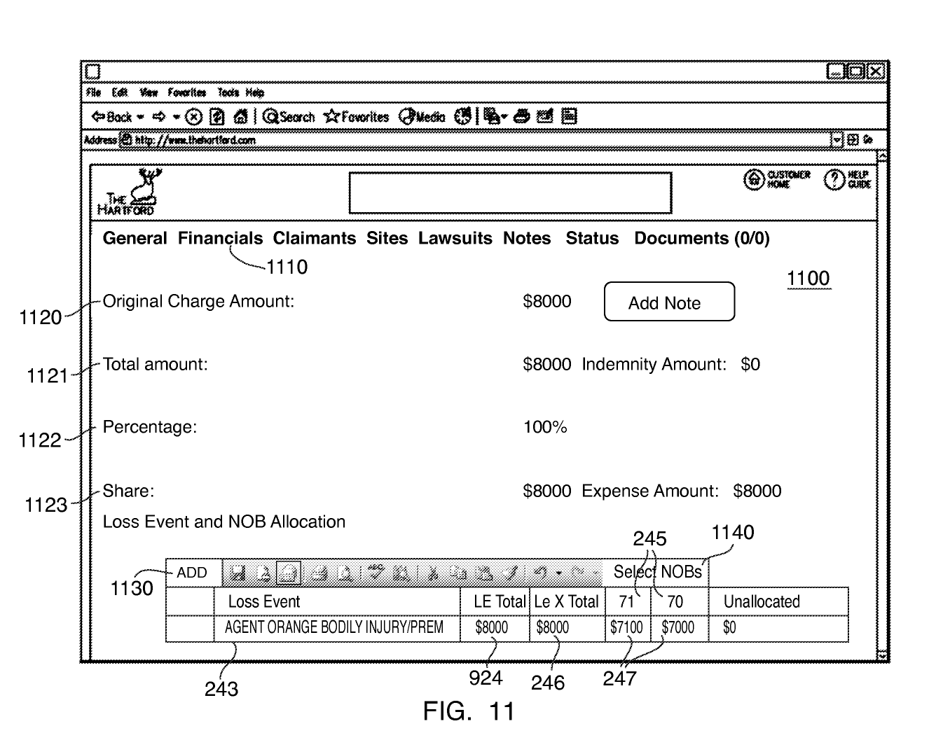

The graphical user interface 1100 of FIG. 11 shows the Financial tab 1110 associated with the creation of an invoice file 240. The graphical user interface 1100 of FIG. 11 allows a user to enter information regarding the Original Amount 1120 of the invoice, the Total Amount 1121 of the invoice after any adjustments and/or deductions, the Insurer Share Amount 1123 based on an Insurer Share Percentage 1122 of the Total Amount 1121, Nature of Benefit (NOB) Code(s) 245, the Loss Event Total 1114, the Loss Event(s) Insurer Total(s) 246, and NOB Code(s) Total(s) 247.

Graphical user interface 1100 allows a user to input the Original Amount 1120 of the invoice, the Total Amount 1121 of the invoice after any adjustments and/or deductions, and an Insurer Share Percentage 1122. The Insurer Share Percentage 1122 may be determined based on insurance coverage allocations among other insurers. Based on the Total Amount 1121 and the Insurer Sharer Percentage 1122, the Account Portal application program 218A may automatically calculate the Insurer Share Amount 1123. For example, if it is determined that the Insurer Share Percentage 1122 is 50%, then the Insurer Share Amount 1123 is 50% of the Total Amount 1121. The Insurer Sharer Amount preferably reflects the Share Percentage for all related entities of the insurer.

In order to ensure balancing at all levels, the user may indicate the portion of the Total Amount 1121 of the invoice to be allocated to one or more loss events 243 associated with the invoice 240. Graphical user interface 1100 allows a user to identify one or more loss events 243 associated with the invoice file 240 by selecting the Add button 1130 and identifying the corresponding loss events 243. Once all of the loss events associated with the invoice 240 have been identified, the user can allocate some portion of the Total Amount 1121 of the invoice to each loss event. In graphical user interface 1100, the portion of the Total Amount 1121 of the invoice allocated to a loss event is referred to as Loss Event Total 1124. As shown in the example of FIG. 11, if there is only one loss event associated with the invoice file 240, then the Loss Event Total 1124 is the same as the Total Amount 1121. Additionally, based on the Loss Event Total 1124 and the Insurer Sharer Percentage 1122, the Account Portal application program 218A may automatically calculate the Loss Event Insurer Total 246. As shown in the example of FIG. 11, if it is determined that the Insurer Share Percentage 1122 is 100%, then the Loss Event Insurer Total 246 is 100% of the Loss Event Total 1124.

Furthermore, all dollars may be allocated to a Nature of Benefit (NOB) code 245. A NOB code 245 is used to identify the categories of benefits to which a payment is allocated. Graphical user interface 1100 allows a user to identify one or more NOB Codes 245 associated with the invoice file 240 by selecting the Select NOBs button 1140. When the user selects the Select NOBs button 1140, the user is directed to graphical user interface that allows a user to select the NOB Codes 245 associated with the invoice file 240. Once the user has selected the NOB Codes 245, the NOB Codes 245 associated with the invoice file 240 will be displayed with the one or more loss events 243 associated with the invoice file 240. The user can then allocate a portion of Loss Event Insurer Total 246 to each of the NOB Codes 245 selected. The portions of the Loss Event Insurer Total 246 that are allocated to NOB Codes 245 are referred to as NOB Code(s) Total(s) 247.

When the invoice is ready for payment, the user preferably confirms the invoice file 240. In order to confirm the invoice file 240, the Account Portal application program 218A confirms that all required fields are entered and that the invoice is completely balanced. Once the invoice file 240 is confirmed, the invoice file 240 may be stored by the Account Portal application program 218A to be processed for payment.

Although invoice files 240 have been described as being generated in Account Portal application program 218A based on user inputs, invoice files 240 (i.e., payable items) may be predefined and created in another system, and subsequently transmitted to and stored by Account Portal application program 218A. Accordingly, in some embodiments, step 406 may simply comprise storing one or more invoice files 240 and not generating invoice files 240.

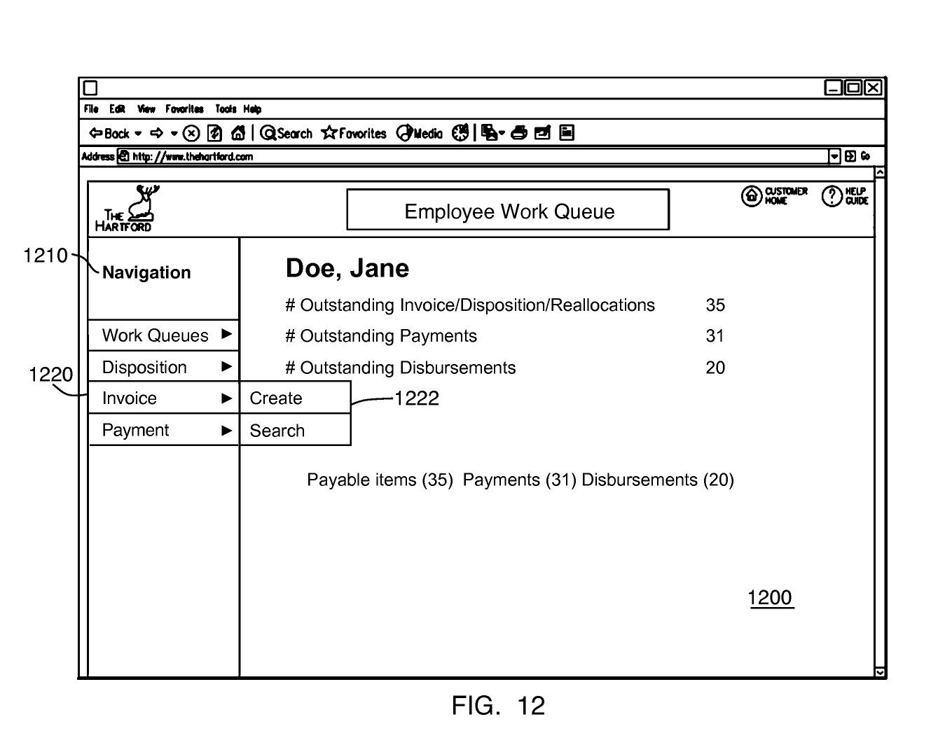

Method 400 may also include a step 408 of generating and storing one or more disposition files associated with one or more of the loss events of step 404, which are associated with the account of step 402. The one or more disposition files referred to in step 408 correspond to the above-described disposition file 250 and may thus be generated in accordance with the above description of disposition file 250. Account Portal application program 218A and Web Interface application program 218B may be executed by CPU 202 to generate secure web-based graphical user interfaces for receiving user inputs for generating a disposition file 250 and for providing a graphical representation of disposition file 250, as shown in FIGS. 12-15. A disposition file 250 represents an indemnity payment and/or a settlement payment of a claim in connection with an insured entity's loss event. For example, a disposition file 250 may be an indemnity payment to an insured entity or a settlement payment to a claimant in connection with a loss event.

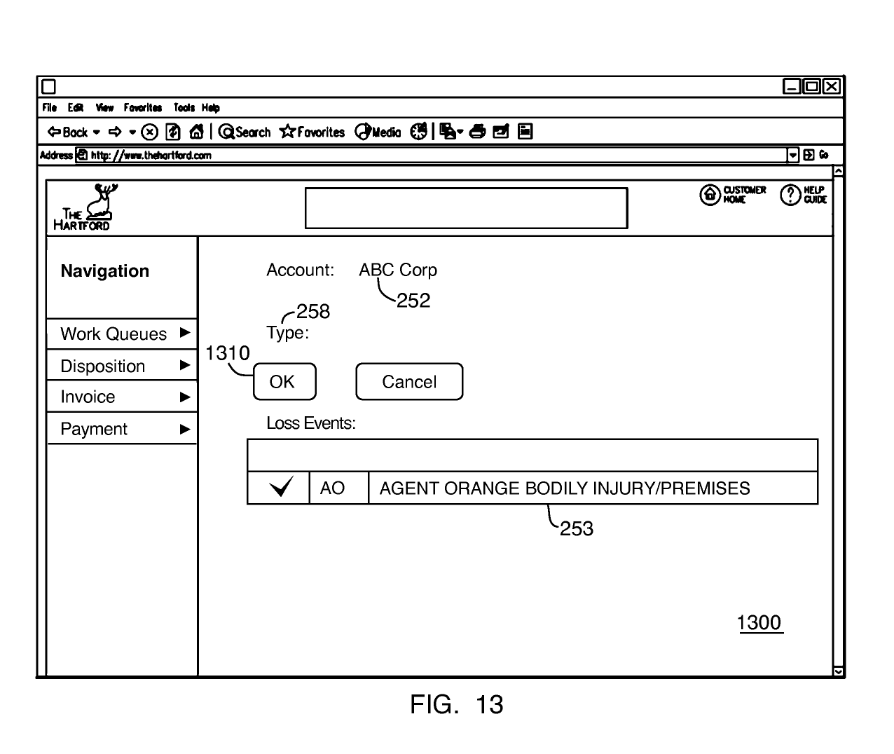

A user may generate a disposition file 250 by accessing secure web-based graphical user interfaces generated by Account Portal application program 218A and Web Interface application program 218B and providing certain user inputs. Step 408 of generating and storing one or more disposition files is described herein with reference to the illustrative embodiments of the secure web-based graphical user interfaces shown in FIGS. 12-15. In one embodiment, a user may begin generating a disposition file 250 by accessing a graphical user interface 1200 as shown in FIG. 12 and selecting the “Disposition” menu item 1220 from the Navigation Menu 1210 and selecting the “Create” option 1222. The user will be directed to a graphical user interface 1300 as shown in FIG. 13.

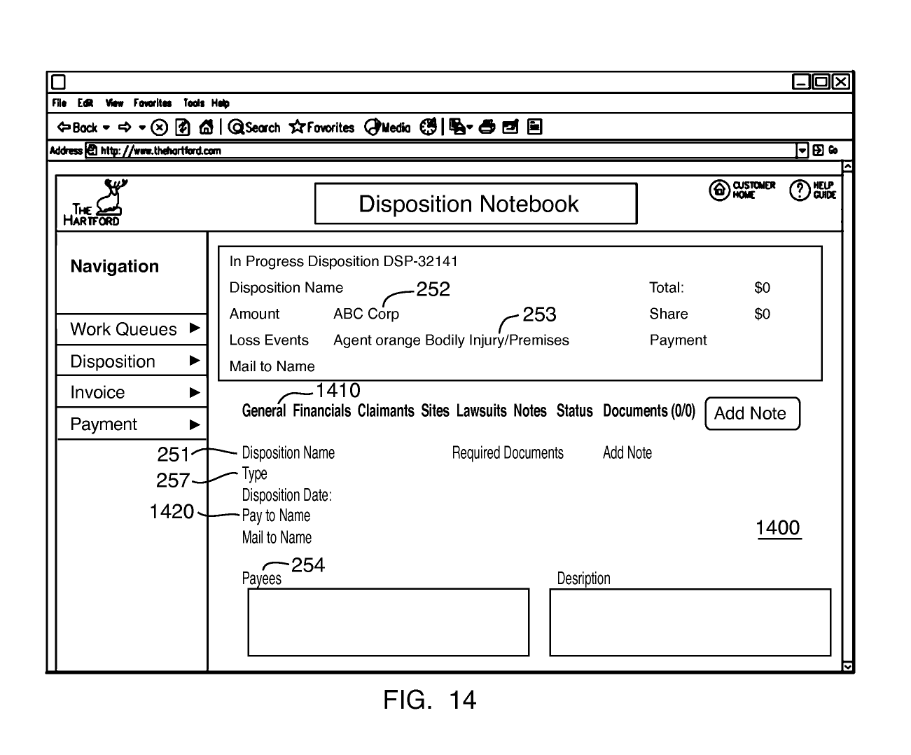

In the graphical user interface 1300 of FIG. 13, a user can enter the associated account name 252, identify the loss events 253 associated with the disposition file 250, and enter the disposition type 258 for the disposition file 250. Disposition type 258 identifies whether the disposition file 250 relates to a partial disposition or a final disposition. A partial disposition refers to a disposition related to an indemnity payment that may be followed by additional indemnity payments in the future. Final disposition refers to a final settlement payment that fully resolves a claim. Once the user inputs the associated account name 252, the loss events 253 associated with the disposition file 250, the disposition type 258 for the disposition file 250, and selects the OK button 1310, the user is directed to the Disposition Notebook graphical user interface 1400 of FIG. 14.

In the Disposition Notebook graphical user interface 1400 of FIG. 14, there are several tabs that can be selected by the user to define different information regarding the disposition file 250. The graphical user interface 1400 of FIG. 14 shows the General tab associated with the creation of a disposition file 250. The graphical user interface 1400 allows the user to enter information regarding the disposition name 251, the disposition date, the payee 254, and the primary payee 1420. Payee 244 represents information identifying the payees corresponding to the disposition file 250. Further, the user may identify a primary payee 1420 to whom a payment check is to be made out.

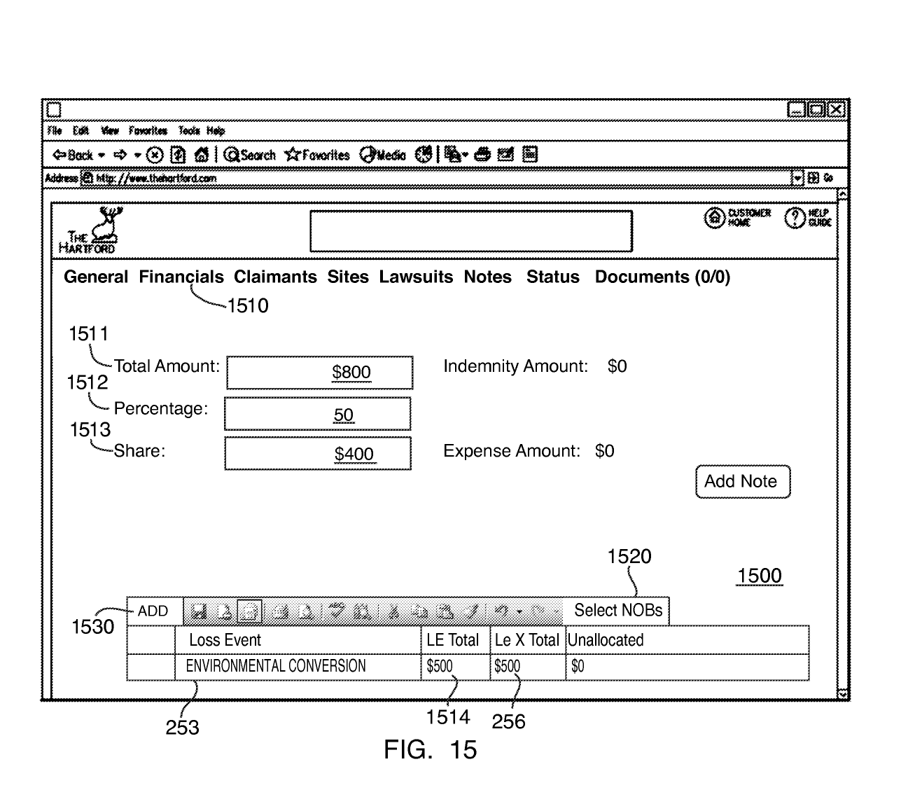

The graphical user interface 1500 of FIG. 15 shows the Financial tab 1510 associated with the creation of a disposition file 250. The graphical user interface 1500 of FIG. 15 allows a user to enter information regarding the Total Amount 1511 of the disposition, the Insurer Share Amount 1513 based on an Insurer Share Percentage 1512 of the Total Amount 1511, Nature of Benefit (NOB) Code(s) 1520, the Loss Event Total 1514, the Loss Event(s) Insurer Total(s) 256, and NOB Code(s) Total(s) 257.

Graphical user interface 1500 allows a user to input the Total Amount 1511 of the disposition, and an Insurer Share Percentage 1512. The Insurer Share Percentage 1512 may be determined based on insurance coverage allocations among other insurers. Based on the Total Amount 1511 and the Insurer Sharer Percentage 1512, the Account Portal application program 218A may automatically calculate the Insurer Share Amount 1513. For example, if it is determined that the Insurer Share Percentage 1512 is 50%, then the Insurer Share Amount 1513 is 50% of the Total Amount 1511. The Insurer Share Amount 1513 preferably reflects the Share Percentage 1512 for all related entities of the insurer.

In order to ensure balancing at all levels, the user may indicate the portion of the Total Amount 1511 of the disposition 250 to be allocated to one or more loss events 253 associated with the disposition 250. Graphical user interface 1500 allows a user to identify one or more loss events 253 associated with the disposition file 250 by selecting the Add button 1530 and identifying the corresponding loss events 253. Once all of the loss events 253 associated with the disposition 250 have been identified, the user can allocate some portion of the Total Amount 1511 of the disposition 250 to each loss event 253. In graphical user interface 1500, the portion of the Total Amount 1511 of the disposition 250 allocated to a loss event 253 is referred to as Loss Event Total 1514. As shown in the example of FIG. 15, if there is only one loss event 253 associated with the disposition file 250, then the Loss Event Total 1514 is the same as the Total Amount 1511. Additionally, based on the Loss Event Total 1514 and the Insurer Sharer Percentage 1512, the Account Portal application program 218A may automatically calculate the Loss Event Insurer Total 256. As shown in the example of FIG. 15, if it is determined that the Insurer Share Percentage 1512 is 50%, then the Loss Event Insurer Total 256 is 50% of the Loss Event Total 1514.

Furthermore, all dollars may be allocated to a Nature of Benefit (NOB) code 255. A NOB code 255 is used to identify the categories of benefits to which a payment is allocated. Graphical user interface 1500 allows a user to identify one or more NOB Codes 255 associated with the disposition file 250 by selecting the Select NOBs button 1520. When the user selects the Select NOBs button 1520, the user is directed to a graphical user interface that allows the user to select the NOB Codes 255 associated with the disposition file 250. Once the user has selected the NOB Codes 255, the NOB Codes 255 associated with the disposition file 250 will be displayed with the one or more loss events 253 associated with the disposition file 250. The user can then allocate a portion of Loss Event Insurer Total 256 to each of the NOB Codes 255 selected. The portions of the Loss Event Insurer Total 256 that are allocated to NOB Codes 255 are referred to as NOB Code(s) Total(s) 257.

A graphical user interface for a Claimants tab associated with the creation of a disposition file 250 may provided to allow a user to enter information identifying a claimant 259 that is part of the disposition 250. The claimant 259 may be identified with information such as claimant's social security number, claimant's injury, claimant's status, lawsuit associated with claimant, and loss event 253 associated with the claimant. Also, a graphical user interface for a Sites tab associated with the creation of a disposition file 250 may be provided to allow a user to identify a site that is part of the disposition. The sites may be identified with information such as the site's damage type and the site's status. The claimant's status and site's status refer to the status as either OPEN or CLOSED for processing. Information regarding the claimant's status and site's status may be stored in the Account Portal application program or in a remote system in communication with the Account Portal application program. For example, information regarding the claimant's status and site's status may be stored in an Electronic Claim Litigation Information Processing System (ECLIPS).

When the disposition is ready for payment, the user preferably confirms the disposition file 250. In order to confirm the disposition file 250, the Account Portal application program 218A confirms that all required fields are entered and that the disposition is completely balanced. Once the disposition file 250 is confirmed, the disposition file 250 may be stored by the Account Portal application program 218A to be processed for payment.

Although disposition files 250 have been described as being generated in Account Portal application program 218A based on user inputs, disposition files 250 (i.e., settlement payments) may be predefined and created in another system, and subsequently transmitted to and stored by Account Portal application program 218A. Accordingly, in some embodiments, step 408 may simply comprise storing one or more disposition files 250 and not generating disposition files 250.

Method 400 may also include a step 410 of generating and storing one or more Electronic Financial Files (EFF). The one or more EFFs referred to in step 410 correspond to the above-described EFF 260 and may thus be generated in accordance with the above description of EFF 260. Account Portal application program 218A and Web Interface application program 218B may be executed by CPU 202 to generate secure web-based graphical user interfaces for receiving user inputs for generating an EFF 260 and for providing a graphical representation of EFF 260. An Electronic Financial File (EFF) 260 corresponds to an insured entity's insurance policy and comprises information regarding one ore more loss events that are associated with the insurance policy. An EFF 260 may be identified by an EFF number 261 and may comprise information regarding an associated account name 262 corresponding to the insured entity associated with one or more loss events; information regarding one or more loss events 263; information identifying an insurance policy 264 (e.g., insurance policy number) corresponding to EFF 260; information identifying the insurer entity 265 that issued the insurance policy 264 corresponding to EFF 260; information regarding spread groups 266 which are linked to EFF 260 and allocate some portion of a payment associated with a loss event to EFF 260; and information regarding the status 267 of the loss event as either OPEN or CLOSED for processing.

Although EFFs 260 have been described as being generated in Account Portal application program 218A based on user inputs, EFFs 260 may be predefined and created in another system, and subsequently transmitted to and stored by Account Portal application program 218A. Accordingly, in some embodiments, step 410 may simply comprise storing one or more EFFs 260 and not generating EFFs 260.

Method 400 may further include a step 412 of receiving a selection of one or more payable files for payment and a step 414 of allocating, across one or more of the EFFs of step 410, an amount to be paid by the insurer for the one or more selected payable files. Steps 412 and 414 are related to the generation of a payment file 270 as described above. A payment represents an account level transaction that groups together for payment one or more payable items that belong to one account (i.e., insured entity) and one payee. Payable items refer to confirmed invoice files 240 and/or disposition files 250 and their corresponding invoice payments, indemnity payments and/or settlement payments. An insured entity generally refers to a policy holder, but may include its corporate predecessors, successors and/or any other related entities that may share insurance coverage under an insurance policy. Payments provide an efficient way of executing a single payment transaction for loss event amounts declared on multiple Payable Items and for allocating the payment to one or more EFFs so that proper accounting of payments corresponding to the insurance policies associated with the one or more EFFs may be properly maintained. Allocation ensures that payments are properly attributed to particular insurance policies for accounting purposes, so that payments allocated to an insurance policy can be validated against insurance policy coverage limits to make sure the insurer is not paying more than it is obligated to pay under the insurance policy agreement. Payments are submitted by an account handler for authorization by an account supervisor. During the authorization process the settlements, invoices, disbursements and EFF allocations are reviewed and approved. Payment allocation is restricted to EFFs that belong to the loss events associated with the selected the payable items.

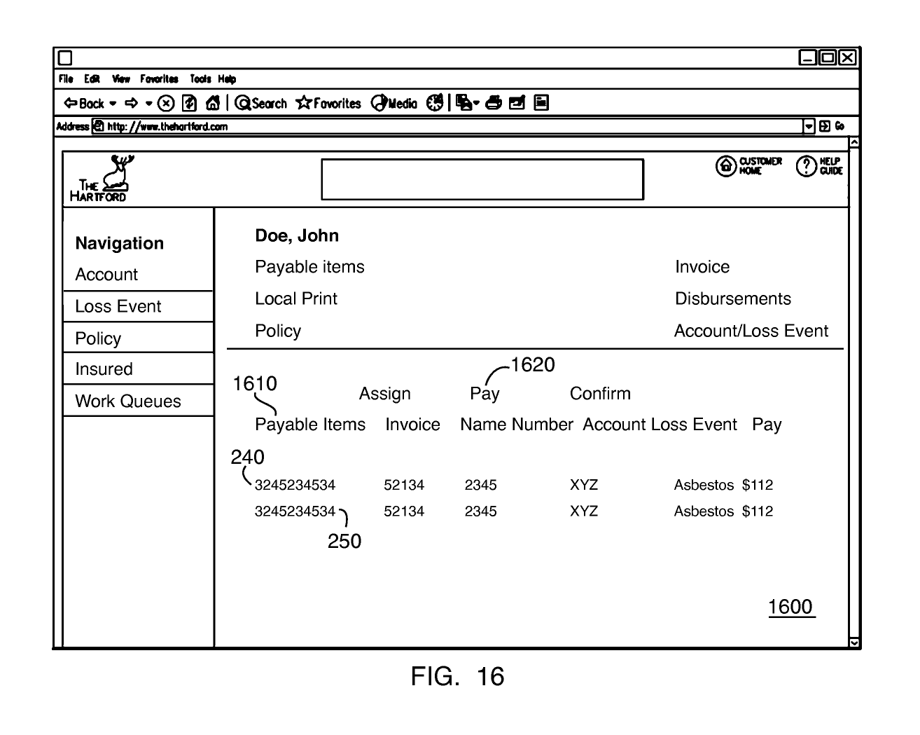

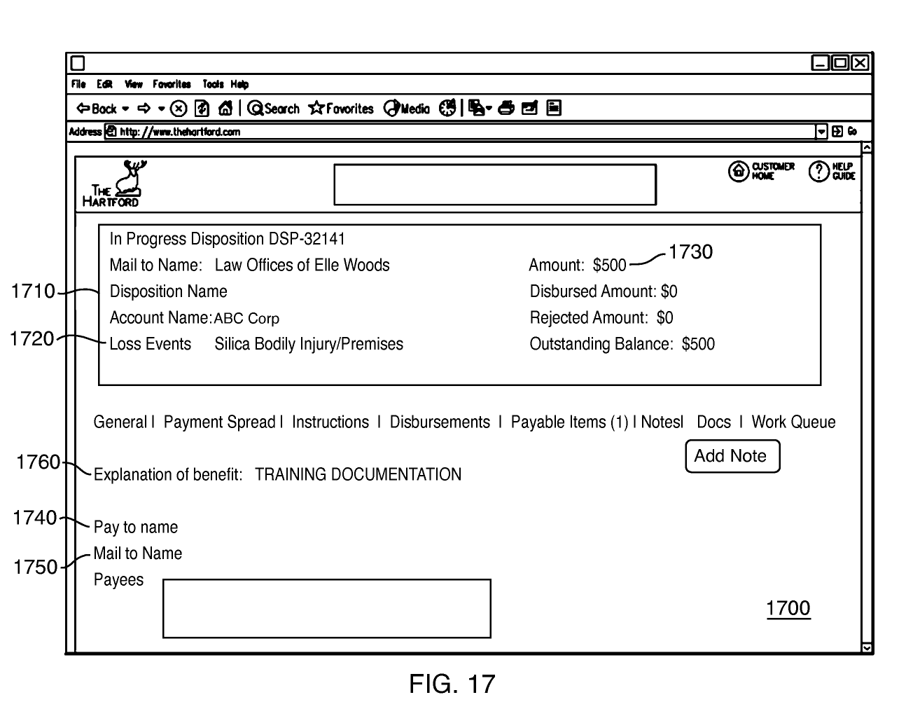

In accordance with a step 412, a user may generate a payment file 270 by accessing secure web-based graphical user interfaces generated by Account Portal application program 218A and Web Interface application program 218B and providing certain user inputs. Step 412 for selecting one or more payable files for payment is described herein with reference to the illustrative embodiments of the secure web-based graphical user interfaces shown in FIGS. 14 and 15. In one embodiment, a user may begin generating a payment file 270 by accessing an Account Portal graphical user interface 500 as shown in FIG. 5 and selecting “Work Queues” 520 from the Menu 510. The user will be directed to a Work Queue graphical user interface 1600 as shown in FIG. 16. From Work Queue graphical user interface 1600, the user can select one or more payable items 1610 (i.e., invoice files 240 and/or disposition files 250) to be paid. Once one or more payable items 1610 have been selected, the user may click of the Pay button 1620, which will direct the user to graphical user interface 1700 as shown in FIG. 17. Some of the information fields in graphical user interface 1700 will be automatically populated based on information in the selected payable items (i.e., invoice files 240 and/or disposition files 250). For example, as shown in FIG. 17, fields in graphical user interface 1700 may be automatically populated with the following information: associated Account Name 1710, associated Loss Event(s) 1720, Payment Total 1730 corresponding to the sum of all Insurer Share Amounts for all selected payable items, payee information 1740, and Mail to information 1750. Further, graphical user interface 1700 may be adapted to receive information regarding an explanation of the benefit 1760 associated with the payment. At this point a payment file 270 is created and can be saved.

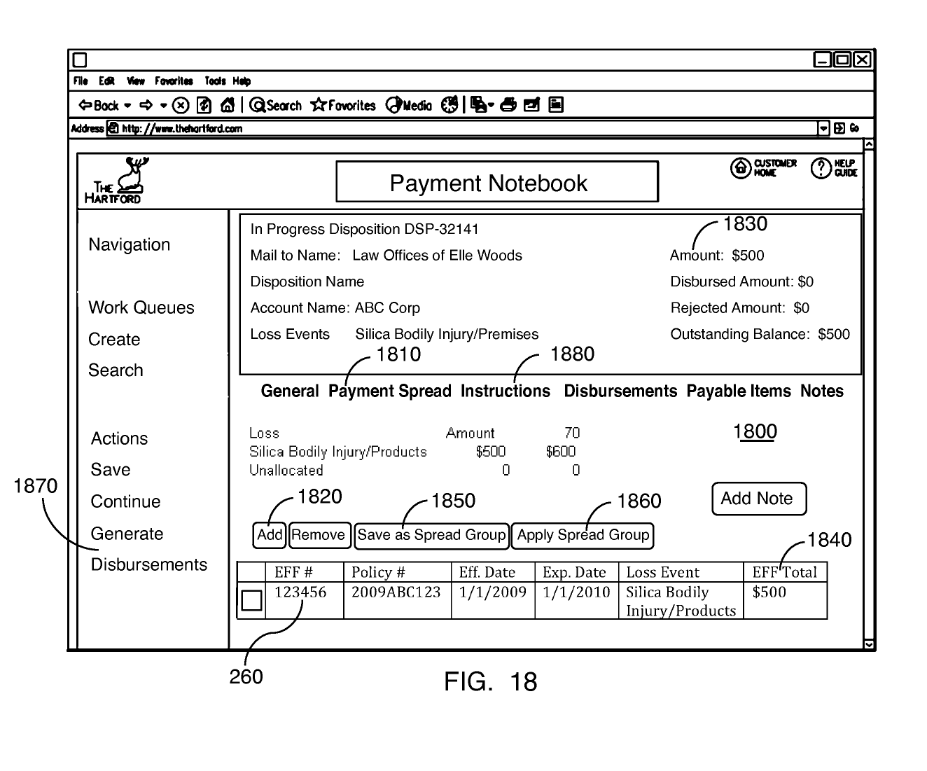

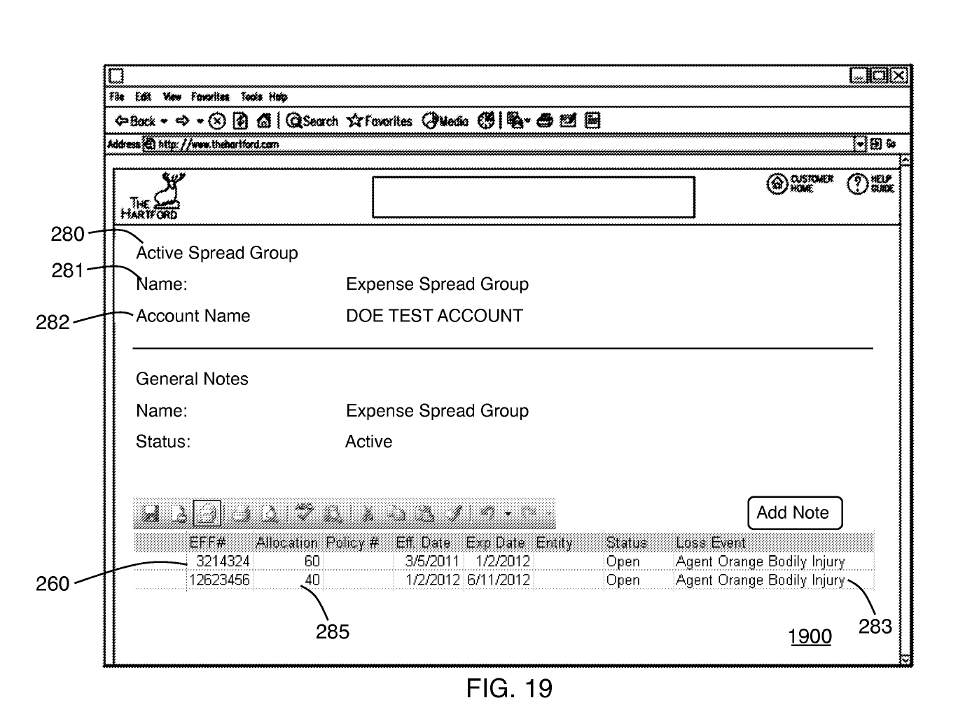

In accordance with a step 414, a user may allocate a Payment Total 1830 corresponding to the sum of all Insurer Share Amounts for all selected payable items across one or more EFFs 260. The user may allocate a Payment Total 1830 to one or more EFFs 260 that are linked to the loss events associated with the selected payable items. Step 414 is described herein with reference to the illustrative embodiments of the secure web-based graphical user interfaces shown in FIGS. 18 and 19. In one embodiment, a user may access a graphical user interface 1800 as shown in FIG. 18 and select EFFs 260 to which to allocate a portion of Payment Total 1830. Graphical user interface 1800 of FIG. 18 shows a Payment Spread tab 1810 associated with the creation of a payment file 270. The user may select and add an EFF 260 to a payment file 270 by clicking the Add button 1820 in graphical user interface 1800. Add button 1820 will launch an EFF searcher that the user can use to identify and select one or more EFFs 260 to add to a payment file 270. The selected EFFs 260 are then added to the Payment Spread tab 1810 of graphical user interface 1800. The user can then allocate a portion of the Payment Total 1830 to each of the selected EFFs 260. In graphical user interface 1800, the portion of the Payment Total 1830 allocated to each of the selected EFFs 260 is identified as EFF Total 1840.

The selection of EFFs and allocation of a Payment Total 1830 to each of the selected EFFs may be saved by the user as a spread group file 280 by clicking the “Save As Spread Group” button 1850 on graphical user interface 1600. A spread group file 280 refers to an EFF allocation 278 that was previously defined in a payment file 270 and was saved to the Account Portal application program 218A. A saved spread group file 280 may be selected and applied to a payment file 270. In one embodiment, as user may allocate a portion of a Payment Total 1830 to one or more EFFs by selecting and applying a save spread group file 280. For example, in the graphical user interface 1800, clicking on the Apply Spread group button 1860 will launch a Spread Group Searcher that the user can use to identify a saved spread group file 280 to be applied to a payment file 270. Selecting and applying a saved spread group file 280 to a payment file 270 will allocate a Payment Total 1830 of payment file 270 to one or more EFFs 260 defined by the saved spread group file 280 and with an allocation 285 defined by the saved spread group file 280. For example, FIG. 19 illustrates a saved spread group file 280 comprising two EFFs 260 and a 65/35 allocation 285 between the two EFFs 260.

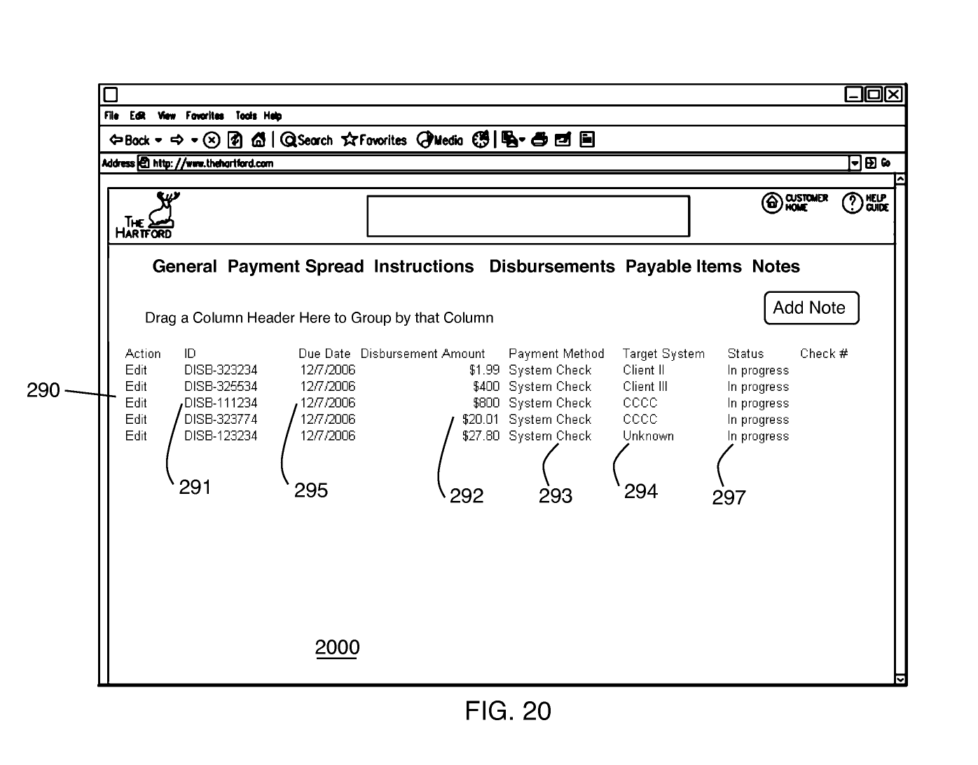

Method 400 may additionally include a step 416 of generating one or more disbursements. Once the Payment Total 1830 of payment file 270 has been completely allocated, the next step is to generate the disbursements. The disbursements can be generated, for example, by selecting the “Generate Disbursements” option 1870 in graphical user interface 1800. The disbursements are then generated and can be viewed on the disbursement tab 1880 of graphical user interface 1800. FIG. 20 illustrates an exemplary graphical user interface 2000 for disbursement tab 1880 showing disbursement files 290. As shown in FIG. 20, each disbursement file 290 may be identified by a disbursement ID 291 and may comprise information regarding the disbursement amount 292, the payment method 293, the target system 294, the due date 295, and the status 297.

A disbursement represents the actual check that gets issued and sent to the payee. The number of disbursements (i.e., checks) that are to be issued in connection with a payment file 270 may depend on various system rules. For example, Account Portal application programs 218A may issue separate disbursements for a payment made for an invoice file 240 (i.e., expense payment) and a disposition file 250 (i.e., indemnity/settlement payment). Accordingly, one disbursement may be made for the expense allocation of the payment and another disbursement may be made of the indemnity/settlement allocation of the payment. Also, different disbursements may need to be issued depending on the target system to which the financial transaction should be entered. The insurer may comprise one or more related business entities of the insurance company that may issue different types of insurance policies and maintain different types of accounting, billing and payment computer systems. Accordingly, the disbursement transaction should be entered to the target system associated with the insurer entity that issued the insurance policy associated with the EFF to which the disbursement was allocated. Thus, different disbursements may need to be issued depending on the number of target systems in which the disbursements need to be entered. Additionally, Account Portal application programs 218A may transmit some disbursements to remote target systems 104, 106 via network 112, as shown in FIG. 1.

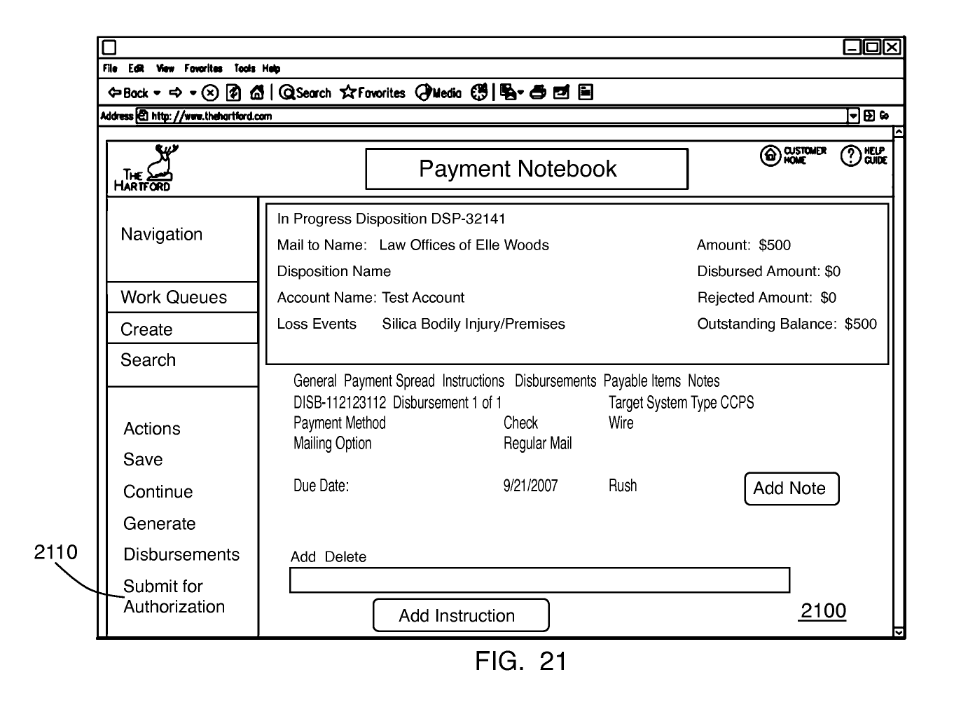

At this point, payment 270 is in a state where it can be submitted for authorization. Once a payment 270 is completely finished (i.e., all data has been entered and the disbursements have been generated), the next step is to submit it for authorization to a supervisor. For example, payment 270 may be submitted for authorization by selecting the “Submit for Authorization” option 2110 in the Instructions tab that is illustrated by the exemplary graphical user interface 2100 shown in FIG. 21. Once a payment 270 is submitted for authorization, Account Portal application programs 218A may transmit payment file 270 for authorization review to a remote computer system 108, 110 via network 112, as shown in FIG. 1.

Although this invention has been shown and described with respect to detailed embodiments thereof, it will be understood by those skilled in the art that various changes in form and detail thereof may be made without departing from the spirit and the scope of the invention. With respect to the embodiments of the systems described herein, it will be understood by those skilled in the art that one or more system components may be added, omitted or modified without departing from the spirit and the scope of the invention. With respect to the embodiments of the methods described herein, it will be understood by those skilled in the art that one or more steps may be omitted, modified or performed in a different order and that additional steps may be added without departing from the spirit and the scope of the invention.

What is claimed is:

1. A computer system for generating a payment associated with an insurance claim, comprising:
a data storage device comprising a database and an Account Portal application program;
the database storing:
one or more invoice files, each of the one or more invoice files defining an amount to be paid by an insurer for a service rendered by a vendor in connection with one or more loss events;
one or more disposition files, each one of the one or more disposition files defining an amount to be paid by the insurer as an indemnity payment and/or a settlement payment in connection with one or more loss events;
a plurality of electronic financial files corresponding to a plurality of liability insurance policies covering a plurality of policy periods;
at least one processor connected to the data storage device for executing the Account Portal application program to:
receive a selection of one or more of the invoice files and/or disposition files for payment;
allocate the amount to be paid by the insurer for the selection of one or more of the invoice files and/or disposition files across the plurality of electronic financial files corresponding to the plurality of liability insurance policies covering the plurality of policy periods; and
generate one or more disbursements for the amount to be paid by the insurer for the selection of one or more of the invoice files and/or disposition files.

2. The system according to claim 1, wherein the at least one processor executes the Account Portal application program to generate a graphical user interface to receive user input for the selection of one or more of the invoice files and/or disposition files for payment.

3. The system according to claim 1, wherein the at least one processor executes the Account Portal application program to generate a graphical user interface to receive user input to allocate, across the plurality of electronic financial files, the amount to be paid by the insurer for the selection of one or more of the invoice files and/or disposition files.

4. The system according to claim 1, wherein the at least one processor executes the Account Portal application program to monitor the allocation of the amount to be paid by the insurer across the plurality of electronic financial files to determine if the allocation exceeds defined limits.

5. The system according to claim 1, wherein the allocation, across the plurality of electronic financial files, of the amount to be paid by the insurer for the selection of one or more of the invoice files and/or disposition files is based on a predefined allocation that is stored in the database.

6. The system according to claim 1, wherein at least one of the one or more disbursements are transmitted to a remote computer system that is in communication with the Account Portal application program executed by the processor.

7. A computerized method for generating a payment associated with an insurance claim, comprising
storing, by the Account Portal application program executed on the computer processor, one or more invoice files, each of the one or more invoice files defining an amount to be paid by an insurer for a service rendered by a vendor in connection with one or more loss events;
storing, by the Account Portal application program executed on the computer processor, one or more disposition files, each one of the one ore more disposition files defining an amount to be paid by the insurer as an indemnity payment and/or a settlement payment in connection with one or more loss events;
storing, by the Account Portal application program executed on the computer processor, a plurality of electronic financial files corresponding to a plurality of liability insurance policies covering a plurality of policy periods;
receiving, by the Account Portal application program executed on the computer processor, a selection of one or more of the invoice files and/or disposition files for payment;
allocating, by the Account Portal application program executed on the computer processor, the amount to be paid by the insurer for the selection of one or more of the invoice files and/or disposition files across the plurality of electronic financial files corresponding to the plurality of liability insurance policies covering the plurality of policy periods; and
generating, by the Account Portal application program executed on the computer processor, one or more disbursements for the amount to be paid by the insurer for the selection of one or more of the invoice files and/or disposition files.

8. The method according to claim 7, wherein the allocating, across the plurality of electronic financial files, of the amount to be paid by the insurer for the selection of one or more of the invoice files and/or disposition files is based on a predefined allocation that is stored by the Account Portal application program.

9. The method according to claim 7, wherein the allocating, across the plurality of electronic financial files, of the amount to be paid by the insurer for the selection of one or more of the invoice files and/or disposition files is based on user input received via a graphical user interface generated by the Account Portal application program executed on the computer processor.

10. The method according to claim 7, further comprising monitoring, by the Account Portal application program executed on the computer processor, the allocation of the amount to be paid by the insurer across the plurality of electronic financial files to determine if the allocation exceeds defined limits.

11. The method according to claim 7, further comprising transmitting, by the Account Portal application program executed on the computer processor, at least one of the one or more disbursements to a remote computer system that is in communication with the Account Portal application program executed on the computer processor.

12. The method according to claim 7, further comprising transmitting, by the Account Portal application program executed on the computer processor, the allocation of the amount to be paid by the insurer across the plurality of electronic financial files to a manager for approval.

13. The method according to claim 7, further comprising identifying, by the Account Portal application program executed on the computer processor, an insured entity and a loss event associated with the insured entity, wherein the one or more of the invoice files and/or disposition files selected for payment are associated with the loss event associated with the insured entity, and wherein the plurality of electronic financial files to which the amount to be paid by the insurer is allocated are also associated with the loss event associated with the insured entity.

14. A non-transitory, tangible computer-readable medium storing instructions adapted to be executed by a computer processor to perform a method for generating a payment associated with an insurance claim, the method comprising the steps of:
storing, by the computer processor, one or more invoice files, each of the one or more invoice files defining an amount to be paid by an insurer for a service rendered by a vendor in connection with one or more of the loss events;
storing, by the computer processor, one or more disposition files, each one of the one ore more disposition files defining an amount to be paid by the insurer as an indemnity payment and/or a settlement payment in connection with one or more of the loss events;
storing, by the computer processor, a plurality of electronic financial files corresponding to a plurality of liability insurance policies covering a plurality of policy periods;
receiving, by the computer processor, a selection of one or more of the invoice files and/or disposition files for payment;
allocating, by the computer processor, the amount to be paid by the insurer for the selection of one or more of the invoice files and/or disposition files across the plurality of electronic financial files corresponding to the plurality of liability insurance policies covering the plurality of policy periods; and
generating, by the computer processor, one or more disbursements for the amount to be paid by the insurer for the selection of one or more of the invoice files and/or disposition files.

15. The non-transitory, tangible computer-readable medium of claim 14, wherein the allocating, across the plurality of electronic financial files, of the amount to be paid by the insurer for the selection of one or more of the invoice files and/or disposition files is based on a predefined allocation that is stored by the Account Portal application program.

16. The non-transitory, tangible computer-readable medium of claim 14, wherein the allocating, across the plurality of electronic financial files, of the amount to be paid by the insurer for the selection of one or more of the invoice files and/or disposition files is based on user input received via a graphical user interface generated by the Account Portal application program executed on the computer processor.

17. The non-transitory, tangible computer-readable medium of claim 14, wherein the method further comprises the step of monitoring, by the computer processor, the allocation of the amount to be paid by the insurer across the plurality of electronic financial files to determine if the allocation exceeds defined limits.

18. The non-transitory, tangible computer-readable medium of claim 14, wherein the method further comprises the step of transmitting, by the computer processor, at least one of the one or more disbursements to a remote computer system that is in communication with the Account Portal application program executed on the computer processor.

19. The non-transitory, tangible computer-readable medium of claim 14, wherein the method further comprises the step of transmitting, by the computer processor, the allocation of the amount to be paid by the insurer across the plurality of electronic financial files to a third party for approval.

20. The non-transitory, tangible computer-readable medium of claim 14, wherein the method further comprises the step of identifying, by the computer processor, an insured entity and a loss event associated with the insured entity, wherein the one or more of the invoice files and/or disposition files selected for payment are associated with the loss event associated with the insured entity, and wherein the plurality of electronic financial files to which the amount to be paid by the insurer is allocated are also associated with the loss event associated with the insured entity.
